(19) United States
(12) Patent Application Publication
(10) Pub. No.: US 2025/0386842 A1
(43) Pub. Date: Dec. 25, 2025

(54) METHOD OF PRODUCING A FLAVOR COMPOSITION

(71) Applicant: PLANET A FOODS GMBH, Planegg (DE)

(72) Inventors: Markus BÖSL, Planegg (DE); Sara MARQUART, Planegg (DE); Sabine MÄHLER, Planegg (DE)

(73) Assignee: PLANET A FOODS GMBH, Planegg (DE)

(21) Appl. No.: 19/305,630

(22) Filed: Aug. 20, 2025

Related U.S. Application Data
(63) Continuation of application No. PCT/EP2024/087973, filed on Dec. 20, 2024.

(30) Foreign Application Priority Data
Dec. 22, 2023 (EP) 23219964.6

(51) Int. Cl. A23L 27/28; A23G 1/34; A23G 3/40; A23L 5/10; A23L 7/10; A23L 27/21

(52) U.S. Cl. CPC A23L 27/28; A23G 1/34; A23G 3/40; A23L 5/10; A23L 7/198; A23L 27/215

(57) ABSTRACT

The present invention relates to a method for preparing a flavor composition, a flavor composition obtainable by said method, a food product containing the flavor composition, and the use of the flavor composition. The present invention further relates to a method for preparing a conched confectionery product and a conched confectionery product obtained by said method.

### CROSS REFERENCE TO RELATED APPLICATIONS

This application is a continuation of International Application No. PCT/EP2024/087973, filed Dec. 20, 2024, which claims the benefit of priority of European Patent Application No. 23219964.6 filed Dec. 22, 2023, the contents of each of which are hereby incorporated by reference in their entirety for all purposes.

### FIELD OF THE INVENTION

The present invention relates to a method for preparing a flavor composition, a flavor composition obtainable by said method, a food product containing the flavor composition, and the use of the flavor composition. The present invention further relates to a method for preparing a conched confectionery product and a conched confectionery product obtained by said method.

### BACKGROUND

Cocoa flavor is the basis for ample food products such as confectionery products and beverages. In 2019, 5.5 million tons of cocoa beans have been harvested worldwide. However, the area where cocoa can be harvested is limited. Furthermore, obtaining the final raw product which can be used for example in the manufacturing of chocolate requires multiple processing steps including harvesting, sorting, fermenting, and drying as well as the shipping costs. This makes cocoa a rather expensive raw material.

In addition, cocoa pricing can be highly volatile, and the industry can experience tight supplies as emerging markets are increasing their consumption of chocolate and cocoa-based products.

Furthermore, the cultivation and production of cocoa bring about numerous negative environmental impacts in order to meet the high worldwide demand, such as extensive greenhouse gas emissions, e.g. due to deforestation and land-use change, a high water footprint, the use of large amounts of herbicides and pesticides, as well as its shipment to destinations where it is further processed in food products such as chocolate.

Therefore, there remains a need to both reduce and/or replace the usage of conventional cocoa obtained from the cocoa tree with a cocoa substitute which is based on natural starting products and which has similar characteristics such as flavor profiles and odor, and can be applied in the same way as conventional cocoa.

There also remains a need to provide a confectionery product in which the usage of conventional cocoa obtained from the cocoa tree can be substantially reduced or even avoided, wherein the confectionery product nevertheless has similar characteristics such as flavor profiles and odor as typical confectionery products with chocolate flavor.

It would be even more advantageous if the natural starting products on which the cocoa substitute is based are byproducts of other production processes which usually are of little economic value anymore or find limited further application, such as kernels and pomace in the production of jams and juices.

It would also be even more advantageous if the natural starting products on which the confectionery product is based and which impart the flavor, for example, the chocolate flavor, are byproducts of other production processes which usually are of little economic value anymore or find limited further application, such as kernels and pomace in the production of jams and juices.

### SUMMARY OF THE INVENTION

The present invention relates to a method of preparing a flavor composition comprising (a) applying vacuum of 500 mbar or less at a temperature of 60-90° C. to a raw composition comprising: (i) 50-99.7 wt.-% (based on dry matter) of a ground material, wherein the ground material is one or more selected from the group consisting of oats, sunflower seeds, apricot kernels, plum kernels, peach kernels, cherry kernels, almond, jackfruit seeds, carob, beans, cereals, pseudo-cereals, non-cereal grains, yeasts, grape seed, fava beans, coffee, cassava root, and cocoa; (ii) 0.2-4 wt.-% (based on dry matter) of the following amino acids: leucine, isoleucine, phenylalanine, lysine, and/or proline; (iii) 0.1-15 wt.-% (based on dry matter) reducing sugar; and (iv) 5-40 wt.-%, preferably 10-40 wt.-% water (of dry matter); until the composition has a moisture content of 15% or lower, 10% or lower, or preferably 7% or lower, to give a dry intermediate product; and (b) roasting the dry intermediate product at a temperature of at least 80° C., preferably 110-180° C. to obtain a roasted product.

The present invention also relates to a flavor composition obtainable by a method of the invention.

The present invention also relates to a cocoa or chocolate flavor composition, comprising a mixture of (i) 50-99.9 wt.-% (based on dry matter) of a ground material, wherein the ground material is one or more selected from the group consisting of oats, sunflower seeds, apricot kernels, plum kernels, peach kernels, cherry kernels, almond, jackfruit seeds, carob, beans, cereals, pseudo-cereals, non-cereal grains, yeasts, grape seed, fava beans, coffee, cassava root, and cocoa; (ii) 0.2-4 wt.-% (based on dry matter) of the following amino acids: leucine, isoleucine, phenylalanine, lysine, and/or proline; (iii) 0.1-15 wt.-% (based on dry matter) reducing sugar; and (iv) 5-40 wt.-%, preferably 10-40 wt.-% water (of dry matter); that has undergone a drying step under vacuum of 500 mbar or less at a temperature of 60-90° C. and subsequently a roasting step at at least 80° C.

The present invention also relates to a method of preparing a conched confectionery product comprising conching a flavor composition of the invention or obtainable by a method of the invention.

The present invention also relates to a conched confectionery product comprising an emulsion of a flavor composition of the invention or obtainable by a method of the invention and an edible fat.

The present invention also relates to a food product containing a flavor composition of the invention or obtainable by a method of the invention or a conched confectionary product of the invention or obtainable by a method of the invention.

The present invention also relates to a use of a flavor composition of the invention or obtainable by a method of the invention or a conched confectionary product of the invention or obtainable by a method of the invention as a cocoa or chocolate substitute.

### BRIEF DESCRIPTION OF THE DRAWINGS

FIG. 1: Sensory analysis (n=10) of CPE, prepared according to Example 1; Roasted at different temperatures.

FIG. 2: Sensory analysis (n=10) of CPE, prepared according to Example 2; Roasted for different time periods.

FIG. 3: Sensory analysis (n=10) of CPE, prepared according to Example 3; Different amino acid and sugar amounts added.

FIG. 4: Moisture content in CPE prepared according to Example 4, during the drying step of dry incubation at different pressures at 65° C. with following roasting at 150° C.

FIG. 5: Sensory analysis (n=11) of the aroma of dark chocolate substitute made of dry incubated oats and sunflower seeds compared to wet incubation and genuine dark chocolate (“semi-sweet”)

FIG. 6: Sensory analysis (n=11) of the aroma of dark chocolate substitute made of dry incubated raw material compared to wet incubation and genuine dark chocolate (“semi-sweet”). A. Fava bean. B. Buckwheat. C. Oat, sunflower seeds and carob.

FIG. 7: Sensory analysis (n=10) of the aroma of dark chocolate substitutes made of dry incubated sunflower seeds and dried spent coffee grounds (Experiment A), Carob (Experiment B), and Cocoa and Oat (Experiment C).

FIG. 8: Sensory analysis (n=10) of a chocolate alternative prepared with the presented method, a chocolate alternative of a competitor and real chocolate

FIG. 9: Peak areas in GC-MS analysis of samples; Sum of aldehydes: 3-methylbutanal, 2-methylbutanal, 2-methylpropanal; Sum of pyrazines: 3-ethyl-2,5-dimethylpyrazine, 3-ethyl-2,5-dimethylpyrazine, 2-ethyl-6-methylpyrazine, 2-methyl-6-propoxypyrazine, 2,3-diethyl-5-methylpyrazine, 2,3-dimethylpyrazine.

FIG. 10: Peak areas in GC-MS analysis of a cocoa powder equivalent (CPE) made by the former wet Incubation (“WetInc-CPE”) and of a CPE made by the new dry Incubation (“Dry Inc-CPE”). Analysed were the Lipid oxidation markers E-2,4-decadienal, E-oct-2-enal, 1-octen-3-ol, hexanal and 2-pentylfuran.

FIG. 11: Two chocolate substitutes were made with the same recipe from a cocoa powder equivalent (CPE) made by the former wet Incubation (“Wet Inc”) and of a CPE made by the new dry Incubation (“Dry Inc”). The chocolate substitutes were tempered and moulded and the hardness was analysed by a texture analyser.

### DETAILED DESCRIPTION

The present invention is based on the surprising finding, that the flavor profile of a cocoa or chocolate substitute can be improved by modifying its preparation process. In previous processes, (granulous) plant materials are commonly soaked in a large amount of an aqueous solution comprising sugars and amino acids, commonly at a raw material to water ratio of 1:1 to 1:3, then dried at ambient pressure, and subsequently roasted.

While the previous process already yielded in the flavor composition that can be used as a cocoa alternative, the inventors of the present application, however, have surprisingly found that the flavor profile of the flavor composition can be further improved by modifying the previous process.

The modifications include the use of ground material as raw material and reducing the water content in the raw composition. Further, during the drying step, a reduced pressure (vacuum) is applied. With the modified process, removes off-flavor components derived from the raw material can be efficiently removed and process time can be shortened. As a result, a flavor composition can be produced, which—after roasting—has a more chocolate-like flavor profile as compared to previous processes, as shown in Examples 6 and 7.

Moreover, using the flavor composition produced according to the present invention, chocolate substitutes can be produced which has a flavor profile or that is very close to real chocolate as shown in Example 8.

Accordingly, the present invention relates to method of preparing a flavor composition comprising (a) applying vacuum of about 500 mbar or less at a temperature of preferably at least 60° C., such as about 60-110° C., preferably about 60-90° C. to a raw composition comprising: (i) about 50-99.7 wt.-% (based on dry matter) of a ground (raw) material, (ii) about 0.2-4 wt.-% (based on dry matter) of the following amino acids: leucine, isoleucine, phenylalanine, lysine, and/or proline; (iii) about 0.1-15 wt.-% (based on dry matter) reducing sugar; and (iv) water (about 5-40 wt.-%, preferably about 10-40 wt.-% of dry matter) to give a dry intermediate product; and (b) roasting the dry intermediate product to obtain a roasted product.

As used herein, the term “flavor” refers to one or more sensory stimuli, such as, for example, one or more taste (gustatory), smell (olfactory), touch (tactile), and temperature (thermal) stimuli. The term “aroma” refers to sensory stimuli that can be perceived by the sense of smell (olfactory). The sensory experience of a subject exposed to a flavor may be classified as a characteristic experience for the particular flavor. For example, a flavor can be identified by the subject as being a floral, citrus, berry, nutty, caramel, chocolate, peppery, smoky, cheesy, meaty, etc. flavor. As used herein, a flavor composition can be selected from a liquid, dry powder, spray, paste, suspension, and any combination thereof. The flavor can be a natural composition, an artificial composition, a nature-identical, or any combination thereof.

As used herein, the term “flavor profile” refers to a combination of sensory stimuli, for example, tastes, such as sweet, sour, bitter, salty, kokumi, and/or umami tastes, and/or olfactory, tactile, and/or thermal stimuli. The flavor profile may comprise one or more flavors that contribute to the sensory experience of a subject. Modifying, changing, or varying the combination of stimuli in a flavor profile may change the sensory experience of a subject.

As used herein, the term “flavor composition” refers to at least one, two, three, four, five, or more compounds or biologically acceptable salts thereof that modulate, including enhancing, multiplying, potentiating, decreasing, suppressing, or inducing, the tastes, smells and/or flavors of a natural or synthetic tastant, flavoring agent, taste profile, flavor profile and/or texture profile in an animal or a human. The flavor composition may comprise a combination of compounds or biologically acceptable salts thereof. The flavor composition may further include one or more excipients.

By applying vacuum, off-flavor components that are contained in the raw material can be removed from the mixture, which may result in an improved flavor profile of the final product.

As raw material, a great variety of ground material can be used. A ground material can, e.g., be a meal, a flour or a powder. The ground material is preferably a ground plant material and/or ground yeast.

As used herein, the term “plant material” is meant to comprise the mentioned material as such but also comprises processed products or side-products thereof such as press cakes, pomace, polished grains, and spent grounds, as well as parts of the respective plant material such as shells, grape skins, marc, pods, and pulp.

A ground material can be or comprise ground oats, sunflower seeds, apricot kernels, plum kernels, peach kernels, cherry kernels, almond, jackfruit seeds, carob, beans, such as fava beans, cereals, pseudo-cereals, non-cereal grains, yeast, grape seed, coffee, cassava root, and/or cocoa. A ground material can preferably be or comprise ground oats, sunflower seeds, apricot kernels, plum kernels, peach kernels, cherry kernels, almond, jackfruit seeds, carob, cereals, pseudo-cereals, non-cereal grains, yeast, grape seed, coffee, cassava root, and/or cocoa. The raw material can comprise a combination of the aforementioned materials, such as combination of 1, 2, 3, or 4, or even more of the aforementioned materials.

Exemplary cereals, pseudo-cereals, and non-cereal grains include corn, maize, oat, barley, rye, wheat, millet, sorghum, rice, quinoa, amaranth, buckwheat, and the like. Exemplary beans include fava beans.

Preferred ground materials are ground oats, sunflower seeds, buckwheat, fava bean, cocoa beans, grape seeds, cassava roots, coffee beans, carob, and/or corn, such as oats flour, sunflower meal, buckwheat flour, fava bean flour, cocoa bean powder, grape seed flour, cassava root flour, coffee grounds, carob powder, and/or corn flour.

Preferred ground materials are also ground oats, sunflower seeds, buckwheat, fava bean, grape seeds, cassava roots, coffee beans, carob, and/or corn, such as oats flour, sunflower meal, buckwheat flour, fava bean flour, grape seed flour, cassava root flour, coffee grounds, carob powder, and/or corn flour.

A ground material is preferably a meal or a powder. The ground material is preferably de-oiled. As used herein “de-oiled” refers to a ground material that has a reduced oil-content as compared to the original plant material. An example for a de-oiled material is for example a press cake. An example for a de-oiled material is for example an oil cake. An example for a de-oiled ground material is a meal or powder made from a press-cake, such as a sunflower seeds meal obtained from a sunflower seeds press cake. An example for a de-oiled ground material is a meal or powder made from a oil cake, such as a sunflower seeds meal obtained from a sunflower seeds oil cake.

A ground material can comprise ground sunflower seeds. The sunflower seeds can be whole sunflower seeds and/or from press cakes, with press cakes being preferred. The sunflower seeds can be sunflower seeds from oil cakes. Ground sunflower seeds, such as sunflower meal, can be used as sole ground material or in mixture with other ground materials, preferably another ground material disclosed herein, such as ground oats, buckwheat, fava bean, cocoa beans, grape seeds, cassava roots, coffee beans, carob, and/or corn, with ground oats, carob, coffee beans, grape seeds, and/or corn being preferred.

As used herein, the term “press cake” refers to the residue of the oil production, of oleaginous plant materials (e.g. seeds, or fruits), such as olives, apricot kernels, canola, linseed, sunflower, etc. The residue is derived from pressing or milling the plant materials, to recover the oil for further applications (food, cosmetics, and the like). The residue is rich in protein and/or carbohydrates. A preferred ground material is a ground material is obtained from a press cake and/or is a ground press cake. As used herein, the term “oil cake” refers to the residue of the oil production, that can be derived from pressing or milling or any other means or method of oil production. Such other means can include, e.g., chemical extraction of the plant material, for example hexane extraction. Said other means can also include, e.g., distillation of the plant material. Also a preferred ground material is a ground material is obtained from an oil cake and/or is a ground oil cake.

A ground material can comprise ground buckwheat, such as buckwheat flour. Ground buckwheat, such as buckwheat flour, can be used as sole ground material or in mixture with other ground materials, preferably another ground material disclosed herein, such as ground oats, sunflower seeds, fava bean, cocoa beans, grape seeds, cassava roots, coffee beans, carob, and/or corn.

A ground material can comprise ground fava beans, such as fava bean flour. Ground fava beans, such as fava bean flour, can be used as sole ground material or in mixture with other ground materials, preferably another ground material disclosed herein, such as ground oats, sunflower seeds, buckwheat, cocoa beans, grape seeds, cassava roots, coffee beans, carob, and/or corn.

A ground material can comprise ground cocoa beans. As used herein, the term “cocoa” also comprises cacao. The term “cocoa” refers to processed products derived from the Theobroma cacao fruit, in particular the seeds thereof (cacao beans), such as fermented, roasted, alkalized, ground, and pressed cacao beans. The term “cacao” refers to the unprocessed products derived from the Theobroma cacao fruit, in particular the seeds (cacao beans) thereof. Cocoa beans can be fermented or non-fermented. Cocoa beans can also be roasted or unroasted. Preferably, cocoa beans are fermented and unroasted. The ground cocoa bean can be powdered cocoa beans, preferably powdered fermented and unroasted cocoa beans. Ground cocoa beans can be used as sole ground material or in mixture with other ground materials, preferably another ground material disclosed herein, such as ground oats, sunflower seeds, buckwheat, fava bean, grape seeds, cassava roots, coffee beans, carob, and/or corn, such as ground oats. When used as sole raw material, the methods of then invention can be used to improve the roasting process of cocoa beans. In particular, if the cocoa beans that are used are of poor quality, the methods of the present invention can be used to give roasted cocoa (powder) that has an improved flavor profile.

A ground material can comprise ground grape seeds. Ground grape seeds, such as grape seed flour, can be used as sole ground material or in mixture with other ground materials, preferably another ground material disclosed herein, such as ground oats, sunflower seeds, buckwheat, fava bean, cocoa beans, cassava roots, coffee beans, carob, and/or corn, such as ground sunflower seeds.

A ground material can comprise ground cassava roots. Ground cassava roots, such as cassava root flour, can be used as sole ground material or in mixture with other ground materials, preferably another ground material disclosed herein, such as ground oats, sunflower seeds, buckwheat, fava bean, cocoa beans, grape seeds, cassava roots, coffee beans, carob, and/or corn.

A ground material can comprise ground coffee beans. Ground coffee beans, such as coffee grounds can be spent coffee ground. Coffee ground is preferably used in mixture with other ground materials, preferably another ground material disclosed herein, such as ground oats, sunflower seeds, buckwheat, fava bean, cocoa beans, grape seeds, cassava roots, carob, and/or corn, preferably sunflower seeds. Alternatively, coffee ground can be used as sole ground material.

A ground material can comprise ground carob. Ground carob, such as carob powder, can be used as sole ground material or in mixture with other ground materials, preferably another ground material disclosed herein, such as ground oats, sunflower seeds, buckwheat, fava bean, cocoa beans, grape seeds, cassava roots, coffee beans, and/or corn, preferably oats and/or sunflower seeds.

A ground material can comprise ground corn. Ground corn, such as corn flour, can be used as sole ground material or in mixture with other ground materials, preferably another ground material disclosed herein, such as ground oats, sunflower seeds, buckwheat, fava bean, cocoa beans, grape seeds, cassava roots, coffee beans, and/or carob, preferably oats and/or sunflower seeds.

A preferred ground material comprises, essentially consists of, or consists of a mixture of oats and sunflower seeds. The mixture may comprise about 10% to about 90% sunflower seeds and about 10% to about 90% oats, such as about 10% to about 80% sunflower seeds and about 20% to about 90% oats, such as about 10% to about 70% sunflower seeds and about 30% to about 90% oats, such as about 10% to about 60% sunflower seeds and about 40% to about 90% oats, such as about 10% to about 50% sunflower seeds and about 50% to about 90% oats, such as about 20% to about 50% sunflower seeds and about 50% to about 80% oats, such as about 20% to about 40% sunflower seeds and about 60% to about 80% oats, such as about 30% to about 40% sunflower seeds and about 60% to about 70% oats, such as about 35% to about 40% sunflower seeds and about 60% to about 65% oats, such as about 37% sunflower seeds and about 63% oats (all values given as wt. % based on dry matter).

A preferred ground material comprises, essentially consists of, or consists of fava beans. The ground material may comprise at least about 50%, at least about 60%, at least about 70%, at least about 80%, at least about 90%, at least about 95%, at least about 98%, at least about 99%, or about 100% fava beans (all values given as wt. % based on dry matter).

A preferred ground material comprises, essentially consists of, or consists of buckwheat. The ground material may comprise at least about 50%, at least about 60%, at least about 70%, at least about 80%, at least about 90%, at least about 95%, at least about 98%, at least about 99%, or about 100% buckwheat (all values given as wt. % based on dry matter).

A preferred ground material comprises, essentially consists of, or consists of a mixture of oats, sunflower seeds and carob. The ground material may comprise about 10% to about 90% of oats, about 10% to about 90% of sunflower seeds and about 10% to about 90% of carob, such as about 10% to about 80% of oats, about 10% to about 80% of sunflower seeds and about 10% to about 80% of carob, such as about 10% to about 70% of oats, about 10% to about 70% of sunflower seeds and about 10% to about 70% of carob, such as about 10% to about 60% of oats, about 10% to about 60% of sunflower seeds and about 10% to about 60% of carob, such as about 10% to about 50% of oats, about 10% to about 50% of sunflower seeds and about 10% to about 50% of carob, such as about 20% to about 50% of oats, about 20% to about 50% of sunflower seeds and about 20% to about 50% of carob, such as about 20% to about 40% of oats, about 20% to about 40% of sunflower seeds and about 20% to about 40% of carob, such as about 30% to about 40% of oats, about 30% to about 40% of sunflower seeds and about 30% to about 40% of carob, such as about 30% to about 35% of oats, about 30% to about 35% of sunflower seeds and about 30% to about 35% of carob, such as about 33% of oats, about 33% of sunflower seeds and about 33% of carob (all values given as wt. % based on dry matter).

A preferred ground material comprises, essentially consists of, or consists of carob. The ground material may comprise at least about 50%, at least about 60%, at least about 70%, at least about 80%, at least about 90%, at least about 95%, at least about 98%, at least about 99%, or about 100% carob (all values given as wt. % based on dry matter).

A preferred ground material comprises, essentially consists of, or consists of a mixture of sunflower seeds and coffee beans. The ground coffee beans are preferably spent and dried coffee grounds. The mixture may comprise about 50% to about 99% sunflower seeds and about 1% to about 50% coffee beans, such as about 60% to about 98% sunflower seeds and about 2% to about 40% coffee beans, such as about 70% to about 97% sunflower seeds and about 3% to about 30% coffee beans, such as about 75% to about 96% sunflower seeds and about 4% to about 25% coffee beans, such as about 80% to about 95% sunflower seeds and about 5% to about 20% coffee beans, such as about 85% to about 95% sunflower seeds and about 5% to about 15% coffee beans, such as about 87% to about 93% sunflower seeds and about 7% to about 13% coffee beans, such as about 90% sunflower seeds and about 10% coffee beans (all values given as wt. % based on dry matter).

A preferred ground material comprises, essentially consists of, or consists of a mixture of oats and cocoa beans. The cocoa beans are preferably powdered fermented and unroasted cocoa beans. The mixture may comprise about 10% to about 90% oats and about 10% to about 90% cocoa beans, such as about 20% to about 80% oats and about 20% to about 80% cocoa beans, such as about 30% to about 70% oats and about 30% to about 70% cocoa beans, such as about 40% to about 60% oats and about 40% to about 60% cocoa beans, such as about 45% to about 55% oats and about 45% to about 55% cocoa beans, such as about 50% oats and about 50% cocoa beans (all values given as wt. % based on dry matter).

A preferred ground material comprises, essentially consists of, or consists of sunflower seeds. The ground material may comprise at least about 50%, at least about 60%, at least about 70%, at least about 80%, at least about 90%, at least about 95%, at least about 98%, at least about 99%, or about 100% sunflower seeds (all values given as wt. % based on dry matter).

A preferred ground material comprises, essentially consists of, or consists of oats. The ground material may comprise at least about 50%, at least about 60%, at least about 70%, at least about 80%, at least about 90%, at least about 95%, at least about 98%, at least about 99%, or about 100% oats (all values given as wt. % based on dry matter).

A preferred ground material comprises, essentially consists of, or consists of a mixture of sunflower seeds and grape seeds. The mixture may comprise about 50% to about 99% sunflower seeds and about 1% to about 50% grape seeds, such as about 60% to about 98% sunflower seeds and about 2% to about 40% grape seeds, such as about 70% to about 97% sunflower seeds and about 3% to about 30% grape seeds, such as about 75% to about 96% sunflower seeds and about 4% to about 25% grape seeds, such as about 80% to about 95% sunflower seeds and about 5% to about 20% grape seeds, such as about 85% to about 95% sunflower seeds and about 5% to about 15% grape seeds, such as about 87% to about 93% sunflower seeds and about 7% to about 13% grape seeds, such as about 90% sunflower seeds and about 10% grape seeds (all values given as wt. % based on dry matter).

A preferred ground material comprises, essentially consists of, or consists of cassava roots. The ground material may comprise at least about 50%, at least about 60%, at least about 70%, at least about 80%, at least about 90%, at least about 95%, at least about 98%, at least about 99%, or about 100% cassava roots (all values given as wt. % based on dry matter).

A preferred ground material comprises, essentially consists of, or consists of a mixture of sunflower seeds, oats, and corn. The ground material may comprise about 10% to about 90% of sunflower seeds, about 10% to about 90% of oats and about 10% to about 90% of corn, such as about 10% to about 80% of sunflower seeds, about 10% to about 80% of oats and about 10% to about 80% of corn, such as about 10% to about 70% of sunflower seeds, about 10% to about 70% of oats and about 10% to about 70% of corn, such as about 10% to about 60% of sunflower seeds, about 10% to about 60% of oats and about 10% to about 60% of corn, such as about 20% to about 60% of sunflower seeds, about 20% to about 60% of oats and about 10% to about 40% of corn, such as about 25% to about 50% of sunflower seeds, about 25% to about 50% of oats and about 10% to about 30% of corn, such as about 30% to about 50% of sunflower seeds, about 30% to about 50% of oats and about 10% to about 30% of corn, such as about 35% to about 45% of sunflower seeds, about 35% to about 45% of oats and about 15% to about 25% of corn, such as about 40% of sunflower seeds, about 40% of oats and about 20% of corn (all values given as wt. % based on dry matter).

According to the disclosure, the raw composition comprises 0.2-4 wt.-% of the following amino acids: leucine, isoleucine, phenylalanine, lysine, and/or proline, such as 0.25-3.5 wt.-%, 0.3-3 wt.-%, 0.35-2.5 wt.-%, 0.4-2 wt.-%, 0.45-1.5 wt %, or 0.5-1 wt % of said amino acids (all values based on dry matter). Preferably, the raw composition comprises all of leucine, isoleucine, phenylalanine, lysine, proline. However, it is also possible that the raw composition comprises 1, 2, 3, or 4 of said amino acids.

The terms “leucine”, “isoleucine”, “phenylalanine”, “lysine”, and “proline” encompass the respective free amino acid, but may also encompass derivates of said amino acids, such as acetylated leucine, acetylated isoleucine, acetylated phenylalanine, acetylated lysine, and acetylated proline. It is however preferred that terms “leucine”, “isoleucine”, “phenylalanine”, “lysine”, and “proline” only encompass the respective free amino acid. The leucine, isoleucine, phenylalanine, lysine, and proline are preferably Maillard-reactive.

According to the disclosure, the raw composition comprises about 0.1-15 wt.-%, such as about 0.5-10 wt.-%, about 1-8 wt.-%, about 1.5-6 wt.-%, or about 2-5 wt.-% reducing sugar (all values based on dry matter).

Generally, a reducing sugar is any sugar that is capable of acting as a reducing agent. A reducing sugar can be a monosaccharide or a disaccharide. A reducing sugar is preferably Maillard-reactive.

Exemplary sugars are glucose, fructose, ribose, xylose, mannose, galactose, lactose, and/or maltose. The reducing sugar according to the disclosure may be a mixture of different reducing sugars. Accordingly, the reducing sugar may be a mixture of glucose, fructose, ribose, xylose, mannose, galactose, lactose, and/or maltose. Preferred reducing sugars are glucose and/or fructose. Also preferred is a mixture of glucose and fructose. The mixture can comprise about 1-10 parts of glucose to about 1-10 parts of fructose, about 1-5 parts of glucose to about 1-5 parts of fructose, about 1-4 parts of glucose to about 1-4 parts of fructose, about 1-3 parts of glucose to about 1-3 parts of fructose, about 1-2 parts of glucose to about 1-2 parts of fructose, about 1 part of glucose to about 1-3 parts of fructose, about 1 part of glucose to about 1,5-2,5 parts of fructose, or about 1 part of glucose to about 2 parts of fructose (all values based on dry matter).

For example, the raw composition may comprise about 0.1-15 wt % glucose and about 0.1-15 wt % fructose, such as about 0.2-10 wt % glucose and about 0.2-10 wt % fructose, about 0.3-8 wt % glucose and about 0.3-8 wt % fructose, about 0.4-6 wt % glucose and about 0.4-6 wt % fructose, about 0.5-5 wt % glucose and about 0.5-5 wt % fructose, about 0.6-4 wt % glucose and about 0.6-4 wt % fructose, about 0.7-3 wt % glucose and about 0.8-3.5 wt % fructose, about 0.8-2 wt % glucose and about 1-3 wt % fructose, about 0.9-1.5 wt % glucose and about 1.5-2.5 wt % fructose, about 1 wt % glucose and about 2 wt % fructose (all values based on dry matter).

Generally, amino acids and reducing sugars can be added to the raw composition as individual compounds. However, it is also possible that amino acids and/or reducing sugars are comprised in a composition and that said composition is added to the raw material. For example, it is possible to pre-mix the amino acids and/or the reducing sugars that are to be added to the raw composition. It is also possible to use a composition which already comprises a mixture of amino acids and/or reducing sugars. Examples for such compositions include, but are not limited to hydrolyzed yeast extract, hydrolyzed plant or animal protein, or hydrolyzed starch rich material, such as high fructose corn sirup.

According to the present disclosure, the raw composition comprises 5-40 wt.-%, optionally 6-40 wt.-%, 7-40 wt.-%, 8-40 wt.-%, 9-40 wt.-%, or preferably 10-40 wt.-% water (of dry matter in the raw composition). The raw composition may comprise about 10-35 wt.-% water, or about 15-30 wt.-% water (all values given as percentage relative to dry matter in the raw composition).

Step (a) of the method of preparing a flavor composition may be considered as a drying step. Here, a vacuum is applied at a temperature of about 60-90° C. Drying is conducted, until the composition has a moisture content of about 15% or lower, about 14% or lower, about 13% or lower, about 12% or lower, about 11% or lower, about 10% or lower, about 9% or lower, about 8% or lower, or preferably about 7% or lower.

As used herein, the term “drying” refers to a process of the removal of water from a mixture. Generally, drying can be carried out via different methods such as microwave-assisted drying, freeze-drying, spray drying, freeze concentration, drying under reduced pressure, thin layer drying, convectional heating, conductional heating and the like. In the context of the present invention, however, drying is carried out as described for step (a).

By applying vacuum during step (a), both, the time for drying can be reduced and undesired off-flavor compounds can be removed. Hence, step (a) preferably comprises a vacuum of about 500 mbar or less, such as about 400 mbar or less, about or about 300 mbar or less. For example, step (a) may comprise applying a vacuum of about 0.1-500 mbar, about 0.1-400 mbar, or about 0.1-300 mbar. The lower limit for the aforementioned ranges may also be higher, such as about 1-500 mbar, about 1-400 mbar, or about 1-300 mbar; about 5-500 mbar, about 5-400 mbar, or about 5-300 mbar; about 10-500 mbar, about 10-400 mbar, or about 10-300 mbar. Preferably, a vacuum of about 250 mbar or less, about 200 mbar or less, about 150 mbar or less, or about 100 mbar or less can be applied, such as about 0.1-250 mbar, about 0.1-200 mbar, about 0.1-150 mbar, or about 0.1-100 mbar. The lower limit for the aforementioned ranges may also be higher, such as about 1-250 mbar, about 1-200 mbar, about 1-150 mbar, or about 1-100 mbar; about 5-250 mbar, about 5-200 mbar, about 5-150 mbar, or about 5-100 mbar; or about 10-250 mbar, about 10-200 mbar, about 10-150 mbar, or about 10-100 mbar. An even stronger vacuum can be applied, such as about 90 mbar or less, about 80 mbar or less, about 70 mbar or less, about 50 mbar or less, about 40 mbar or less, or about 35 mbar or less. For example, one can apply a vacuum of about 0.1-90 mbar, about 0.1-80 mbar, about 0.1-70 mbar, about 0.1-60 mbar, about 0.1-50 mbar, about 0.1-40 mbar, or about 0.1-35 mbar. As another example, one can apply a vacuum of about 1-90 mbar, about 1-80 mbar, about 1-70 mbar, about 1-60 mbar, about 1-50 mbar, about 1-40 mbar, or about 1-35 mbar. As another example, one can apply a vacuum of about 5-90 mbar, about 5-80 mbar, about 5-70 mbar, about 5-60 mbar, about 5-50 mbar, about 5-40 mbar, or about 5-35 mbar. As another example, one can apply a vacuum of about 10-90 mbar, about 10-80 mbar, about 10-70 mbar, about 10-60 mbar, about 10-50 mbar, about 10-40 mbar, or about 10-35 mbar. For example, one can apply a vacuum of about 32 mbar, about 200 mbar or about 500 mbar, with about 32 mbar being preferred. The vacuum to be applied is preferably a vacuum that is technically feasible, even if no lower limit is defined.

Step (a) can be conducted at any temperature that is suitable for drying. For example, the temperature may be from about 50° C.-about 95° C., such as about 50° C. to about 90° C., about 60° C. to about 90° C., about 60° C. to about 80° C. or about 60° C. to about 70° C. As an illustrative example, step (a) may be conducted at about 65° C.

According to the present disclosure, the vacuum in step (a) is applied until the composition has a moisture content of about 15% or lower, about 14% or lower, about 13% or lower, about 12% or lower, about 11% or lower, about 10% or lower, about 9% or lower, about 8% or lower, preferably about 7% or lower, such as about 6% or lower, preferably about 5% or lower. For example, the vacuum in step (a) is applied until the composition has a moisture content of about 2% to about 15%, about 2% to about 14%, about 2% to about 13%, about 2% to about 12%, about 2% to about 11%, about 2% to about 10%, about 2% to about 9%, about 2% to about 8%, preferably about 2% to about 7%, such as about 4% to about 6%, about 4.5% to about 5.5%, or about 5%. The dry intermediate product obtained in step (a) may have a water activity (Aw value) of about 0.3 to 0.6.

In step (a), by applying a vacuum, off-flavor and/or undesired flavor compound can be depleted and/or removed. The type of undesired and/or off-flavor compound may depend on the raw material that is used. Examples for undesired flavor compounds that can be depleted and/or removed are acetoin, alpha-pinene, beta-pinene, (E,E,Z)-2,4,6-nonatrienal, (E,E)-2,4-decadienal, hexanal, E-2-nonenal; nonanal, and/or hexanoic acid. Acetoin typically gives a buttery aroma and is e.g. commonly contained in sunflower seeds, alpha-pinene gives a pine-like aroma and is e.g. commonly contained in sunflower seeds, Beta-pinene gives a pine-like aroma and is e.g. commonly contained in sunflower seeds. (E,E,Z)-2,4,6-nonatrienal gives a oatmeal-like aroma and is e.g. commonly contained in oats. (E,E)-2,4-decadienal gives a chicken fat like aroma and is e.g. commonly contained in oats and/or buckwheat. Hexanal gives a “green” and grassy aroma and is e.g. commonly contained in oats and/or fava beans. E-2-nonenal gives a fatty and “green” aroma and is e.g. commonly contained in fava beans and/or buckwheat. Nonanal gives a aldehydic aroma and is e.g. commonly contained in carob, Hexanoic acid gives a fatty aroma and is e.g. commonly contained in carob.

It is also possible to collect, fractionate and/or isolate at least one flavor compound from exhaust air in step (a), in particular from the condensate of the exhaust air. Such flavor compound can optionally be added again to the roasted product obtained in (b). Examples of flavor compounds that can be collected, fractionated and/or isolated and optionally added back to the roasted product include, but are not limited to pyrazines, such as trimethyl pyrazine, esters, such as butyl acetate, aldehydes, such as 2-/3-methylbutanal, and/or alcohols, such as phenyl ethanol.

Prior to step (a), the method of the invention may optionally contain an incubation step, in which the raw composition is incubated at about 50-80° C. for about 120 min or less, such as about 5-120 minutes, such as about 5-60 min.

According to the present disclosure, the raw composition can be prepared by mixing ground material, water, amino acids and reducing sugar. The components can be mixed together in any order. For example, the raw composition can be prepared by (i) providing ground material, (ii) providing water, and (iii) providing amino acids and reducing sugars. Water can, e.g., be added either in as liquid, e.g., via a spray nozzle. Water can also be added, e.g., in form of steam.

According to the present disclosure, in step (b) the intermediate product is roasted to give a roasted product. Generally, roasting can be conducted by any suitable method that is know to the skilled person. Roasting can be conducted at a temperature of at least about 80° C., such as about 80° C. to about 200° C. Preferably, roasting is conducted at a temperature from about 110° C. to about 180° C., more preferably at a temperature of about 110° C. to about 160° C. For example, roasting can be conducted at a temperature of about 130° C. to about 160° C. or about 140° C. to about 160° C., such as about 145° C. to about 155° C., such as about 150° C.

Roasting can be conducted for about 5 min to about 120 min. Generally, the optimum roasting time can vary depending on the temperature. Higher temperatures usually result in shorter roasting times, whereas a lower temperatures usually result in a longer roasting times. For example, roasting can be conducted for about 10 min to about 120 min, such as about 15 min to about 120 min, about 15 min to about 60 min, about 15 min to about 50 min, about 20 min to about 45 min, or about 40 min. As an illustrative example, roasting temperature can be about 130° C. to about 170° C. and roasting time can be about 10 min to about 60 min. As another illustrative example, roasting temperature can be about 140° C. to about 160° C. and roasting time can be about 15 min to about 50 min.

Generally, roasting can be conducted under ambient pressure or reduced pressure. However, ambient pressure is preferred.

After step (b) the method of the disclosure may further comprise cooling the roasted product. Cooling can be conducted by any suitable method that is known to the skilled person.

After step (b), further ingredients may be added to the roasted product. For example, oil and/or fat can be added roasted product. However, ingredients to be added can also comprise one or more of, including all of the following: sugar, milk powder, oat flower, aroma, fat, lecithin, and/or colouring agents.

According to the disclosure, the method of preparing a flavor composition is preferably for producing a cocoa or chocolate flavor composition. A flavor composition of the disclosure is preferably substantially free of cocoa or cocoa-derived solids. Preferably, the ground material in step (a) is substantially free of cocoa or cocoa-derived material. Accordingly, the flavor composition prepared by the method of the disclosure is preferably a cocoa or chocolate flavor composition. Such flavor composition is preferably substantially free of cocoa or cocoa-derived solids.

The present disclosure also contemplates that step (a) and/or step (b) are conducted under agitation, preferably, steps (a) and step (b) are both conducted under agitation.

The present disclosure also contemplates that the roasted product obtained in step (b) may further be subjected to milling. Milling can be conducted directly on the roasted product, of after the addition of further ingredients disclosed herein to the roasted product. Milling can be conducted by any suitable means or method that is know to the skilled person, such as using a ball mill or a 3-roll roller grinder. Milling can be conducted until the desired particle size is reached. For example, a particle size D50 of about 600 μm may be desired for a flavor composition which can be applied as a cocoa powder substitute. Hence, milling can be conducted until a particle size D50 of about 600 μm is reached. As another example, fine particles having a particle size (D90) of <30 um may be desired for a flavor composition that is subsequently conched. Hence, milling can be conducted until a particle size (D90) of <30 μm is reached.

The term “particle size” or “volume-based particle size” or “volume-based particle size distribution” as used herein is equivalent to and also referred to as the Dv50 or D50 and means that at least about 50% of the particles have a diameter of less than the size specified. The aforementioned terms are used interchangeably herein. For example, a volume-based particle size (Dv50) of less than about 1000 nm, means that 50% of the particle population has a diameter of less than about 1000 nm when measured by static or dynamic light scattering techniques known to those skilled in the art. Unless otherwise specified, all particle sizes are specified in terms of volume-based measurements and are measured by laser light scattering/diffraction. The terms “D90” and “D10” mean that respectively at least about 90% and 10% of the particles have a diameter of less than the size specified. These may also be referred to as “Dv90” and “Dv10” respectively, and these terms are used interchangeably herein.

The present invention also relates to a flavor composition obtainable by the method of the invention. Embodiments and/or features that have been described in the context of a method of producing the flavor composition apply likewise to the flavor compositions described herein, in particular to a flavor composition that is obtainable by a method of producing the flavor composition of the disclosure.

The present invention also relates to a flavor composition, preferably a cocoa or chocolate flavor composition, comprising a mixture of (i) 50-99.9 wt.-% (based on dry matter) of a ground material, wherein the ground material is one or more selected from the group consisting of oats, sunflower seeds, apricot kernels, plum kernels, peach kernels, cherry kernels, almond, jackfruit seeds, carob, beans, cereals, pseudo-cereals, non-cereal grains, yeasts, grape seed, fava beans, coffee, cassava root, and cocoa; (ii) 0.2-4 wt.-% (based on dry matter) of the following amino acids: leucine, isoleucine, phenylalanine, lysine, and/or proline; (iii) 0.1-15 wt.-% (based on dry matter) reducing sugar; and (iv) 0.5-40 wt.-% water (of dry matter); that has undergone a drying step under vacuum of 500 mbar or less at a temperature of 60-90° C. and subsequently a roasting step at at least 80° C. Said flavor composition is preferably obtainable by a method of producing the flavor composition of the invention. Embodiments and/or features that have been described in the context of a method of producing the flavor composition apply likewise to the flavor compositions described herein, in particular to a flavor composition that is obtainable by a method of producing the flavor composition of the disclosure.

Accordingly, a flavor composition disclosed herein is preferably a cocoa or chocolate flavor composition. A flavor composition is preferably substantially free of cocoa or cocoa-derived solids.

A flavor composition preferably has a flavor profile that resembles the flavor profile of genuine chocolate. The flavor composition may contain one of more compounds that are characteristic for “chocolaty” aroma. Examples for such compounds are 3-methylbutanal, 5-methyl-2-phenyl-2-hexenal, phenylacetaldehyde, trimethylpyrazine, and/or furaneol. The concentration of such compounds can, e.g., be measured by GC, e.g. as essentially described in Example 11. A flavor composition of the disclosure preferably comprises 3-methylbutanal in a concentration as measured by at least 0.1 relative peak area in a GC method as essentially described in Example 11. A flavor composition of the disclosure preferably comprises 5-methyl-2-phenyl-2-hexenal in a concentration as measured by at least 0.1 relative peak area in a GC method as essentially described in Example 11. A flavor composition of the disclosure preferably comprises phenylacetaldehyde in a concentration as measured by at least 0.1 relative peak area in a GC method as essentially described in Example 11. A flavor composition of the disclosure preferably comprises trimethylpyrazine in a concentration as measured by at least 0.1 relative peak area in a GC method as essentially described in Example 11. A flavor composition of the disclosure preferably comprises furaneol in a concentration as measured by at least 0.1 relative peak area in a GC method as essentially described in Example 11. Preferably a flavor composition of the disclosure comprises all of 3-methylbutanal, 5-methyl-2-phenyl-2-hexenal, phenylacetaldehyde, trimethylpyrazine, and furaneol, each in a concentration as measured by at least 0.1 relative peak area in a GC method as essentially described in Example 11.

The present invention also relates to a method of preparing a conched confectionery product comprising conching a flavor composition of the invention or obtainable by a method of producing a flavor composition of the invention. The method of preparing a conched confectionery product may comprise conducting a method of preparing a conched confectionery product as described herein prior to the conching step.

As used herein, the term “conching” refers to a process of mechanical mixing, whereby a surface scraping mixer and agitator, known as a “conche” or “melangeur”, evenly distributes lipids within chocolate and/or chocolate substitutes, and may further reduce the particle size of the cocoa- and non-cocoa solids. Conching is typically carried at elevated temperatures such as from 45° C. to 80° C., for elongated times, such as 1 hour to 72 hours.

According to the disclosure, conching can be carried out at a temperature of from about 40° C. to about 90° C., preferably from about 50° C. to about 70° C. Conching can be conducted for time of at least about 8 minutes, such as a time of from about 10 minutes to about 96 hours, from about 30 minutes to about 48 hours, from about 1 hour to about 24 hours, about 1 hour to about 12 hours. Preferably, conching is conducted for about 1 hour to about 6 hours, such as about 1 hour to about 5 hours, 1 hour to about 4 hours, or about 1 hour to about 3 hours.

Conching is preferably carried out in the presence of a flavor composition of the invention or obtainable by a method of the invention, and a fat component. Optionally, conching can be carried out in the presence of additional ingredients such as sugar and/or milk powder and/or a milk powder substitute.

For example, conching can conducted in the presence of (i) 0.5-30 wt.-% flavor composition of the invention or obtainable by a method of the invention, such as 2-20 wt.-%, such as 8-20 wt.-% (ii) 0-55 wt.-% sugar; (iii) 10-60 wt.-% fat component, such as 20-50 wt.-%; and (iv) 0-30 wt.-% milk powder or milk powder substitute (values are given based on the total weight of the composition). The presence and the amount of the ingredients can vary depending on the desired properties of the conched product.

The fat component may comprise, essentially consists of, or consist of cocoa butter, milk fat, and/or butter oil. The fat component may also comprise, essentially consists of, or consist of one or more cocoa butter replacers, cocoa butter substitutes, or cocoa butter equivalents.

As used herein, the term “cocoa butter replacers” refers to a fat that is derived from hydrogenated and fractionated vegetable fats. It can be used to impart gloss retention and sharp meltdown to the chocolate confectionery products without tempering. Cocoa butter replacer can be mixed with other fats and cocoa, and/or cocoa powder substitutes to produce chocolate confectionery products.

As used herein, the term “cocoa butter substitutes” refers to a confectionery fat substitute. This product can be formulated from hydrogenated and fractionated palm kernel oil. It can be used to give a final chocolate confectionery product a good snappiness, good melting characteristics, and good flavor release without tempering.

As used herein, the term “cocoa butter equivalent” refers to a fat that is specially formulated from palm oil, shea butter, mango kernel fat, sal fat, or illipe butter in order to resemble cocoa butter in both physical and chemical properties. Using this product shows compatibility with cocoa butter and shares similar crystallization and melt profiles. It can be used to provide cost reduction as a cocoa butter substitute at any ratio, imparting strong heat resistance and melting characteristics.

Cocoa butter replacers, cocoa butter substitutes, or cocoa butter equivalents are commercially available and known to the skilled person.

As an illustrative example, the fat component may comprise, essentially consist of, or consist of palm fat and/or shea butter.

As used herein, a milk powder may refer to whole milk powder and/or skimmed milk powder. Examples for milk powder substitutes comprises oat milk powder, oat flour, fava bean powder, fava bean protein, pea milk powder, and/or pea protein.

Conching can also be carried out in the presence of further ingredients, depending on the desired product. Such ingredients may include, but are not limited to: butter fat (e.g., 0-10 wt.-%), aroma compounds, such as vanillin, e.g., 0-1 wt.-%, emulsifiers, such as lecithin, such as soy lecithin or sunflower lecithin, (e.g., 0-1 wt.-%), coloring agents, such as plant extract (e.g. 0-5 wt.-%), malted barley (e.g., 0-20 wt.-%), grape seed flour (e.g., 0-20 wt.-%), and/or salt (e.g. 0-1 wt.-%).

The conched confectionery product according to the disclosure is preferably a chocolate confectionery product. Preferably, the conched confectionery product is substantially free of cocoa or cocoa-derived solids.

As used herein, the term “chocolate”, “chocolates” or “chocolate product” refers to all chocolate or chocolate-like compositions with a fat fraction that can be tempered and that can comprise at least one cocoa or cocoa-like component in this fat fraction. The “fat fraction” of the chocolate according to the present disclosure can comprise cocoa butter, milk fat, butter oil, and other fats that can be tempered such as cocoa butter, or mixtures of cocoa butter with these fats. In the present disclosure, a “fat fraction that can be tempered” means fats that can take different crystalline structures or polymorphs. These fats are typically processed in a tempering process.

As used herein, the term “chocolate substitute” refers to all chocolate-like compositions with a fat fraction that can comprise substantially no cocoa component in this fat fraction. The “fat fraction” of the chocolate substitute according to the present invention can comprise milk fat, butter oil, cocoa butter substitutes, cocoa butter equivalents, algae lipids, biosynthesized lipids, e.g., such as cocoa butter equivalents derived in a fermentation process from yeasts, e.g. genetically modified yeasts, or other fungi, e.g. Rhodosporidium toruloides.

As used herein, the term “chocolate confectionery product” refers to preparations made with chocolate and/or chocolate-substitutes, e.g. bars, snack bars, chips, flakes, fillings, inclusions, coatings, and the like.

The present invention also relates to a conched confectionery product comprising a flavor composition of the invention or obtainable by the method of producing a flavor composition. The conched confectionary product further preferably comprises a fat component. The conched confectionery product is obtainable by the method of preparing a conched confectionery product disclosed herein. Embodiments and/or features that have been described in the context of a method of producing the flavor composition of the disclosure, a flavor composition of the disclosure, and/or a method of of preparing a conched confectionery product of the disclosure apply likewise to the conched confectionery product described herein, in particular to a conched confectionery product that is obtainable by a method of of preparing a conched confectionery product disclosed herein.

A conched confectionery product disclosed herein, preferably comprises of from 0.5 wt.-% to 30 wt.-% flavor composition disclosed herein based on the total weight of the conched confectionery product, preferably of from 2 wt.-% to 20 wt.-% flavor composition based on the total weight of the conched confectionery product.

A conched confectionery product disclosed herein, preferably comprises of from 0.5 wt.-% to 30 wt.-% flavor composition disclosed herein based on the total weight of the conched confectionery product, preferably of from 2 wt.-% to 20 wt.-% flavor composition based on the total weight of the conched confectionery product, such as from 8 wt.-% to 20 wt.-% flavor composition based on the total weight of the conched confectionery product.

A conched confectionery product disclosed herein is preferably a chocolate confectionery product. A conched confectionery product disclosed herein is preferably substantially free of cocoa or cocoa-derived solids.

The present invention also relates to a food product containing the flavor composition of the invention or obtainable by the method of producing the flavor composition of the invention or the conched confectionary product of the invention or obtainable by the method of producing a conched confectionary product of the invention. Embodiments and/or features that have been described in the context of a method of producing the flavor composition of the disclosure, a flavor composition of the disclosure, a method of of preparing a conched confectionery product of the disclosure, and/or a conched confectionary product of the disclosure apply likewise to the conched confectionery product described herein, in particular to a conched confectionery product that is obtainable by a method of of preparing a conched confectionery product disclosed herein.

As used herein, the term “food product” refers to an ingestible product, such as human food and/or animal (pet) foods.

A food product of the disclosure may be selected from the group consisting of a confectionery product, a sweet baked product, an ice cream, a dairy product, a non-dairy product, a beverage, and a snack product.

The present invention also relates to a use of a flavor composition of the invention or obtainable by the method of producing flavor composition of the invention, or a conched confectionary product of the invention or obtainable by a method of producing a conched confectionary product of the invention as a cocoa or chocolate substitute.

As an illustrative example, a flavor composition of the invention or obtainable by the method of producing flavor composition of the invention can be used as cocoa substitute.

As another illustrative example, a conched confectionary product of the invention or obtainable by a method of producing a conched confectionary product of the invention can be used as chocolate substitute.

It must be noted that as used herein, the singular forms “a”, “an” and “the” include plural references and vice versa unless the context clearly indicates otherwise.

Unless otherwise indicated, the term “at least” preceding a series of elements is to be understood to refer to every element in the series.

Those skilled in the art will recognize or be able to ascertain using no more than routine experimentation, many equivalents to the specific embodiments of the invention described herein. Such equivalents are intended to be encompassed by the present invention.

The term “and/or” wherever used herein includes the meaning of “and”, “or” and “all or any other combination of the elements connected by said term”.

The term “about” or “approximately” as used herein means within 20%, preferably within 10%, and more preferably within 5% of a given value or range. It includes, however, also the concrete number, e.g., about 20 includes 20.

As used herein, the term “substantially free of” refers to a mass that is at least 95% free of the named ingredient (such as cocoa), e.g. 95% free of the respective ingredient, such as at least 96%, at least 97%, at least 98%, or at least 99% of the respective ingredient.

Throughout this specification and the claims, unless the context requires otherwise, the word “comprise”, and variations such as “comprises” and “comprising”, will be understood to imply the inclusion of a stated integer or step or group of integers or steps but not the exclusion of any other integer or step or group of integer or step. When used herein the term “comprising” can be substituted with the term “containing” or “including” or sometimes when used herein with the term “having”.

When used herein “consisting of” excludes any element, step, or ingredient not specified in the claim element. When used herein, “consisting essentially of” does not exclude materials or steps that do not materially affect the basic and novel characteristics of the claim.

In each instance herein any of the terms “comprising”, “consisting essentially of” and “consisting of” may be replaced with either of the other two terms. For example, when disclosure uses the term “comprising”, the disclosure also encompasses the replacement of the term “comprising” with the terms “consisting essentially of” as well as “consisting of” and vice versa. E.g., the term “comprising” is meant to provide explicit support also for its replacement with “consisting essentially of” and/or “consisting of”, the term “consisting essentially of” is meant to provide explicit support also for its replacement with “comprising” and/or “consisting of”, and the term “consisting of” is meant to provide explicit support also for its replacement with “consisting essentially of” and “comprising”. The possibility to replace terms with each other is not to be understood that these terms are synonymous. For the avoidance of doubt, the term “comprising”, “consisting essentially of” or “consisting of” that is explicitly recited in the respective context is the preferred term, while its replacement with any one of the other two terms is less preferred.

The invention is further characterized by the following items.

Item 1. A method of preparing a flavor composition comprising
(a) applying vacuum of 500 mbar or less at a temperature of 60-90° C. to a raw composition comprising:
   (i) 50-99.7 wt.-% (based on dry matter) of a ground material, wherein the ground material is one or more selected from the group consisting of oats, sunflower seeds, apricot kernels, plum kernels, peach kernels, cherry kernels, almond, jackfruit seeds, carob, beans, cereals, pseudo-cereals, non-cereal grains, yeast, grape seed, fava bean, coffee, cassava root, and cocoa;

(ii) 0.2-4 wt.-% (based on dry matter) of the following amino acids: leucine, isoleucine, phenylalanine, lysine, and/or proline;
(iii) 0.1-15 wt.-% (based on dry matter) reducing sugar; and
(iv) 5-40 wt.-%, preferably 10-40 wt.-% water (of dry matter);
until the composition has a moisture content of 15% or lower, 10% or lower, or preferably 7% or lower, to give a dry intermediate product; and
(b) roasting the dry intermediate product at a temperature of at least 80° C., preferably 110-180° C. to obtain a roasted product.

Item 2. The method of item 1, wherein the method comprises incubating the raw composition at 50-80° C. for up to 120 minutes before step (a).

Item 3. The method of item 1 or 2, wherein the raw compositions is prepared by
(i) adding ground material,
(ii) adding steam and/or water; and
(iii) adding the amino acids and reducing sugar.

Item 4. The method of any one of the preceding items, wherein the ground material is one or more selected from the group consisting of: oats flour, sunflower meal, buckwheat flour, fava bean flour, cocoa bean powder, grape seed flour, cassava root flour, coffee grounds, carob powder, and corn flour, preferably one or more selected from the group consisting of: oats flour, sunflower meal, buckwheat flour, cocoa bean powder, grape seed flour, cassava root flour, coffee grounds, carob powder, and corn flour.

Item 5. The method of any one of the preceding items, wherein the ground material is selected from:
(a) a mixture of oats and sunflower seeds;
(b) fava beans;
(c) buckwheat;
(d) a mixture of oats, sunflower seeds and carob;
(e) carob;
(f) a mixture of sunflower seeds and coffee beans;
(g) a mixture of oats and cocoa beans;
(h) sunflower seeds;
(i) oats;
(j) a mixture of sunflower seeds and grape seeds;
(k) cassava roots; and
(l) a mixture of sunflower seeds, oats, and corn.

Item 6. The method of any one of the preceding items, wherein the ground material is selected from the group consisting of: oats flour, sunflower meal, or a mixture thereof.

Item 7. The method of any one of the preceding items, wherein the ground material is a de-oiled ground material and/or wherein the ground material is obtained from a press cake or oil cake.

Item 8. The method of any one of the preceding items, wherein the leucine, isoleucine, phenylalanine, lysine, and/or proline are in free or acetylated form, and/or wherein the the leucine, isoleucine, phenylalanine, lysine, and/or proline are Maillard-reactive.

Item 9. The method of any one of the preceding items, wherein the reducing sugar comprises one or more reducing sugars that is a monosaccharide and/or a disaccharide.

Item 10. The method of any one of the preceding items, wherein the reducing sugar comprises one or more reducing sugars selected from the group consisting of glucose, fructose, ribose, xylose, mannose, galactose, lactose, and maltose.

Item 11. The method of any one of the preceding items, wherein the reducing sugar comprises fructose and/or glucose.

Item 12. The method of any one of the preceding items, wherein in step (a) at least one undesired flavor compound is depleted, such as acetoin, alpha-pinene, beta-pinene, (E,E,Z)-2,4,6-nonatrienal, (E,E)-2,4-decadienal, hexanal, E-2-nonenal; nonanal, and/or hexanoic acid.

Item 13. The method of any one of the preceding items, wherein step (a) is conducted until the composition has a moisture content of 5% or lower.

Item 14. The method of any one of the preceding items, wherein the dry intermediate product in (a) has an Aw value of 0.3-0.6.

Item 15. The method of any one of the preceding items, wherein step (b) is carried out for 5-120 min.

Item 16. The method of any one of the preceding items, wherein step (b) is carried out at ambient pressure.

Item 17. The method of any one of items 1-15, wherein step (b) is carried out at reduced pressure.

Item 18. The method of any one of the preceding items, comprising applying vacuum in step (a) and collecting, fractionating and/or isolating at least one flavor compound from exhaust air, and optionally adding the at least one flavor compound to the roasted product obtained in (b).

Item 19. The method of item 18, wherein the at least one flavor compound is selected from the group consisting of pyrazines, such as trimethyl pyrazine, esters, such as butyl acetate, aldehydes, such as 2-/3-methylbutanal, and alcohols, such as phenyl ethanol.

Item 20. The method of any one of the preceding items, further comprising adding fat and/or oil to the roasted product.

Item 21. The method of any one of the preceding items, further comprising cooling the roasted product.

Item 22. The method of any one of the preceding items, wherein steps (a) and/or (b) are conducted under agitation.

Item 23. The method of any one of the preceding items, wherein the flavor composition is a cocoa or chocolate flavor composition.

Item 24. The method of any one of the preceding items, wherein the flavor composition is substantially free of cocoa or cocoa-derived solids.

Item 25. The method of any one of the preceding items, wherein the ground material is substantially free of cocoa or cocoa-derived material.

Item 26. The method of any one of the preceding items, wherein the method comprises adding at least one of the following ingredients after step (b): sugar, milk powder, oat flower, aroma, fat, lecithin, and/or colouring agents.

Item 27. A flavor composition obtainable by the method of any one of items 1-26.

Item 28. A cocoa or chocolate flavor composition, comprising a mixture of
(i) 50-99.9 wt.-% (based on dry matter) of a ground material, wherein the ground material is one or more selected from the group consisting of oats, sunflower seeds, apricot kernels, plum kernels, peach kernels, cherry kernels, almond, jackfruit seeds, carob, beans, cereals, pseudo-cereals, non-cereal grains, yeasts, grape seed, fava beans, coffee, cassava root, and cocoa;
(ii) 0.2-4 wt.-% (based on dry matter) of the following amino acids: leucine, isoleucine, phenylalanine, lysine, and/or proline;
(iii) 0.1-15 wt.-% (based on dry matter) reducing sugar; and
(iv) 5-40 wt.-%, preferably 10-40 wt.-% water (of dry matter);
   that has undergone a drying step under vacuum of 500 mbar or less at a temperature of 60-90° C. and subsequently a roasting step at at least 80° C.

Item 29. The cocoa or chocolate flavor composition of item 28, wherein the cocoa or chocolate flavor composition is obtainable by the method of any one of items 1-26.

Item 30. A method of preparing a conched confectionery product comprising conching a flavor composition of any one of items 27-29 or obtainable by the method of any one of items 1-26.

Item 31. The method of item 30, comprising conducting the method of any one of items 1-26 prior to the conching step.

Item 32. The method of item 30 or 31, wherein conching is carried out at a temperature of from 40° C. to 90° C., preferably from 50° C. to 70° C., and a time of at least 8 minutes, preferably a time of from 10 minutes to 96 hours, more preferably a time of from 30 minutes to 48 hours, and even more preferably a time of from 2 hours to 24 hours.

Item 33. The method of any one of items 30-32, wherein conching is conducted in the presence of
(i) 0.5-30 wt.-% flavor composition of any one of items 27-29 or obtainable by the method of any one of items 1-26;
(ii) 0-55 wt.-% sugar;
(iii) 10-50 wt.-% fat component; and
(iv) 0-30 wt.-% milk powder or milk powder substitute.

Item 34. The method of item 33, wherein the fat component comprises palm fat, and/or shea butter.

Item 35. The method of item 33 or 34, wherein the milk powder comprises whole milk powder and/or skimmed milk powder.

Item 36. The method of any one of items 33-35, wherein the milk powder substitute comprises oat milk powder, oat flour, fava bean powder, fava bean protein, pea milk powder, and/or pea protein.

Item 37. The method of any one of items 33-36, wherein conching is conducted further in the presence of:
(v) 0-1 wt.-% vanillin, and/or
(vi) 0-1 wt.-% lecithin, such as soy lecithin or sunflower lecithin.

Item 38. The method of any one of items 30-37, wherein the conched confectionery product is a chocolate confectionery product.

Item 39. The method of any one of items 30-38, wherein the conched confectionery product is substantially free of cocoa or cocoa-derived solids.

Item 40. A conched confectionery product comprising a flavor composition of any one of items 27-29 or obtainable by the method of any one of items 1-26.

Item 41. The conched confectionery product of item 40, wherein the conched confectionery product is obtainable by the method of any one of items 30-39.

Item 42. The conched confectionery product of item 40 or 41, wherein the conched confectionery product comprises of from 0.5 wt.-% to 30 wt.-% flavor composition based on the total weight of the conched confectionery product, preferably of from 2 wt.-% to 20 wt.-% flavor composition based on the total weight of the conched confectionery product.

Item 43. The conched confectionery product of any one of items 40-42, wherein the conched confectionery product is substantially free of cocoa or cocoa-derived solids.

Item 44. The conched confectionery product of any one of items 40-43, wherein the conched confectionery product is a chocolate confectionery product.

Item 45. A food product containing the flavor composition of any one of items 27-29 or obtainable by the method of any one of items 1-26 or the conched confectionary product of any one of items 40-44 or obtainable by the method of any one of items 30-39.

Item 46. The food product of item 45, wherein the food product is selected from the group consisting of a confectionery product, a sweet baked product, an ice cream, a dairy product, a non-dairy product, a beverage, and a snack product.

Item 47. A use of the flavor composition of any one of items 27-29 or obtainable by the method of any one of items 1-26 or the conched confectionary product of any one of items 40-44 or obtainable by the method of any one of items 30-39 as a cocoa or chocolate substitute.

Item 48. The use of item 47, wherein said flavor composition is used as cocoa substitute or said conched confectionary product is used as chocolate substitute.

### EXAMPLES

### Example 1: Sensory Results of Different Roasting Temperatures

Material/experimental:
62.66% oats flour
37.33% sunflower meal (SFS)
Add amino acids+sugars solution=10% (e.g. 400 g oat/SFS+40 ml water+8 g Fructose, 4 g Glucose, 2.8 g of an amino acid mixture comprising Phe, Leu, Lys, Pro, and Ile)
Everything is mixed thoroughly and then filled in round flask and then connected to rotary evaporator.
Dry incubation process: 65° C., 32 mbar until <5% moisture (about 30 min).
Roasting at Oil temperature set at 105, 120, 135, 150, 165, 180° C. for 40 min.
Sensory: Panelists (10 persons) were asked to rate the samples according to the descriptors seen in the figure, on a scale from 0 to 5. The samples (powdered) where in closed containers until analysis and panelists only rated the smell (no ingestion)

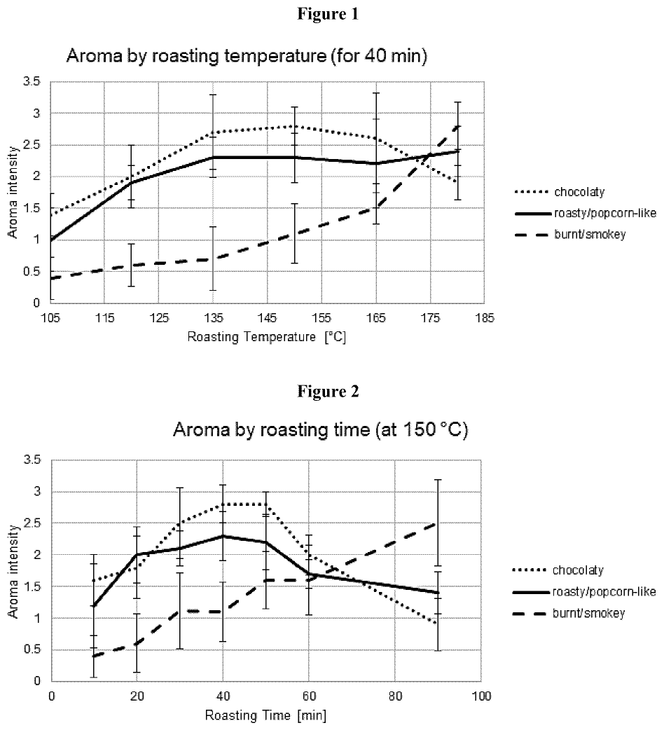

Results are shown in FIG. 1. A wide range of roasting temperatures that can be applied. For a duration of 40 min, an optimum is reached at 150° C., with high chocolaty and roasty aroma, low burnt aroma. A burnt/smokey aroma increased at 165° C., while chocolaty aroma decreases at 185° C. However, roasting temperature and duration are interdependent, and a higher temperature can be compensated with a shorter duration or vice versa.

### Example 2: Sensory Results of Different Roasting Times

Material/experimental:
62.66% oats flour
37.33% sunflower meal (SFS)
Add amino acids+sugars solution=10% (e.g. 400 g oat/SFS+40 ml water+8 g Fructose, 4 g Glucose, 2.8 g of an amino acid mixture comprising Phe, Leu, Lys, Pro, and Ile).
Everything is mixed thoroughly and then filled in round flask and then connected to rotary evaporator
Dry incubation process: 65° C., 32 mbar until <5% moisture (about 30 min)
Roasting at Oil temperature set at 150° C. for 10, 20, 30, 40, 50, 60, 90 min

Results are shown in FIG. 2. A wide range of roasting times that can be applied. For a temperature of 150° C., an optimum is reached at 40 to 50 min, with low burnt/smokey aroma, and high chocolaty/roasty aroma. However, roasting time and temperature are interdependent, and a longer roasting time can be compensated with a lower temperature or vice versa.

### Example 3: Sensory Results of Different Amino Acid/Reducing Sugar Contents

Material/experimental:
62.66% oats
37.33% sf meal
Add AA+sugars solution=10%->concentration of sugar/AA was used as 50%, reference, 150% and 200% of standard concentration (2 g Fructose, 1 g Glucose, 0.7 g of Amino acid mixture comprising Phe, Leu, Lys, Pro, and Ile-based on 100 g oats/SFS)
Everything is mixed thoroughly and then filled in round flask and then connected to rotary evaporator
Dry incubation process: 65° C., 32 mbar until <5% moisture (about 30 min)
Roasting: Oil temperature set at 150° C. for 40 min

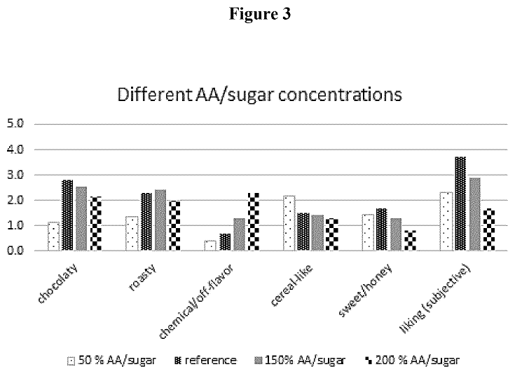

Results are shown in FIG. 3. As evident from the sensory results, a wide range of animo acid concentrations can be used for creating the desired flavor. However, the standard/reference amount of Amino acids are the best option, as the chocolatiness was highest and best results for “liking” was achieved at the standard/reference amount. Chemical off-flavor however increased at 150% or more.

### Example 4: Product Moisture (in %) Over Time (Drying+Roasting)

Material/experimental:
62.66% oats
37.33% sf meal
Add 10% AA+sugars solution (see Example 1)
Everything is mixed thoroughly and then filled in round flask and then connected to rotary evaporator
Dry incubation process: 65° C., 32 mbar, 200 mbar and 500 mbar until <5% moisture
Roasting: Oil temperature set at 150° C. for 40 min@athm pressure

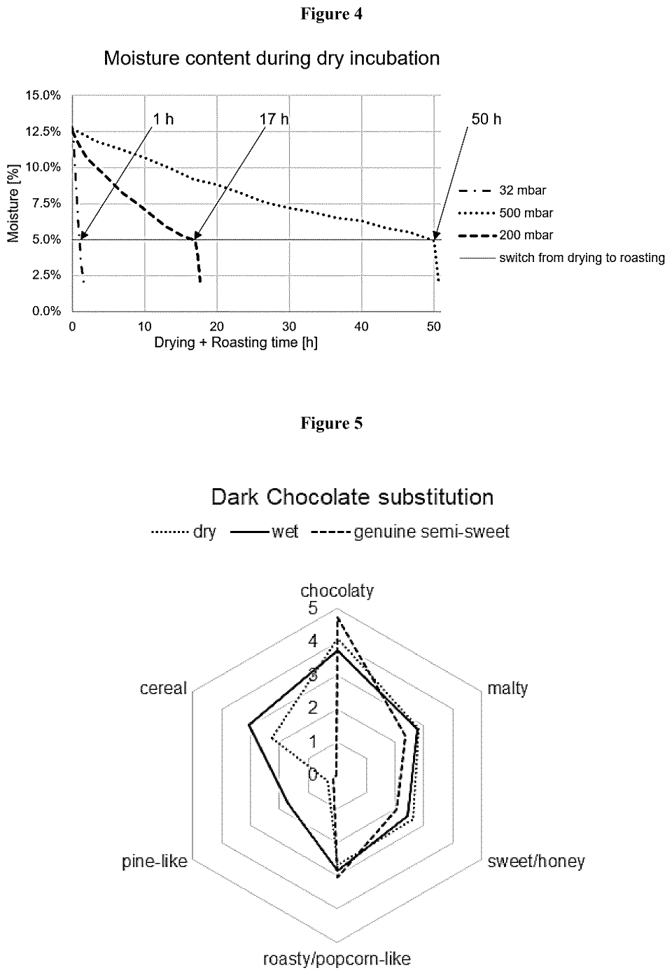

Results are shown in FIG. 4. Application of vacuum strongly reduces drying time.

### Example 5: Sensory Dry Incubation Vs Wet Incubation Vs Cocoa

Material/experimental:
Cocoa powder equivalent was prepared via wet incubation* and dry incubation (150° C. 40 min, example 1) using the exact same ingredients (63% oat, 37% SFS, AA/sugars)
*wet incubation:
   Granular or ground plant material (in this case granular) is steeped/marinated in AA/sugars dissolved in water (in this case the amount of water used was 1:1 by weight) under possible heat application (in this case 90° C. 20 min)
   The plant material is then dried (in this case 65° C. for 12 h in drying oven)
   The plant material is roasted (in this case: drum roaster, 150° C. 7 min)
The cocoa powder equivalents were used to create a dark chocolate alternative (same ingredients as well, see Example 13)
As reference for the sensory a 50% cocoa content semi-sweet chocolate was used
Sensory-panelists (11 persons) were asked to rate the 3 chocolates according to the descriptors seen in the figure, on a scale from 0 to 5.

Results are shown in FIG. 5. Cereal (oats) and pine-like (SFS) off-flavors are decreased in dry incubated samples. Chocolatiness is increased in dry incubated samples. Otherwise, the aroma is similar. However, the overall sensory profile of dry incubated samples more strongly resembles the sensory profile of genuine dark chocolate. This demonstrates the superiority of dry incubation flavor compared to wet incubation flavor.

### Example 6: Sensory of Different Dry and Wet Incubation and Cocoa Samples

Material/experimental:

Cocoa powder equivalent was prepared via wet incubation and dry incubation. The following samples were prepared:
1. Fava beans dry:
   a. 400 g of dry and ground Fava bean
   b. Add 10% AA+sugars solution (see Example 1)
   c. Everything is mixed thoroughly and then filled in round flask and then connected to rotary evaporator
   d. Dry incubation process: 65° C., 32 mbar until <5% moisture
   e. Roasting: Oil temperature set at 150° C. for 40 min
2. Fava beans wet
   a. 100 g Whole fava beans incubated in 100 ml Amino acid sugar solution (2 g Fructose, 1 g Glucose, 0.7 g of Amino acid mixture comprising Phe, Leu, Lys, Pro, and Ile) at 90° C. for 20 min
   b. Drying in oven (65° C., 12 h in drying oven)
   c. Roasting in drum roaster (150° C., 7 min, drum roaster)
   d. Grinding
3. Buckwheat dry
   a. 400 g dry and ground buckwheat
   b. (see Fava beans dry)
4. Buckwheat wet
   a. 100 g Buckwheat incubated in 100 ml Amino acid sugar solution
   b. (see Fava beans wet)
5. Oat/SFS/Carob dry
   a. 134 g (33%) oat flour, 134 g defatted SFS flour, 134 g Carob powder
   b. (see Fava beans dry)
6. Oat/SFS/Carob wet
   a. 33 g oat flour, 33 g sunflower seeds (whole) in 66 ml Amino acid sugar solution
   b. (see Fava beans wet)
   c. 33 g of carob powder are added the way it is (no incubation)
7. A genuine cocoa powder (for baking) was used as a reference

Sensory was performed as described in Example 5 (n=10).

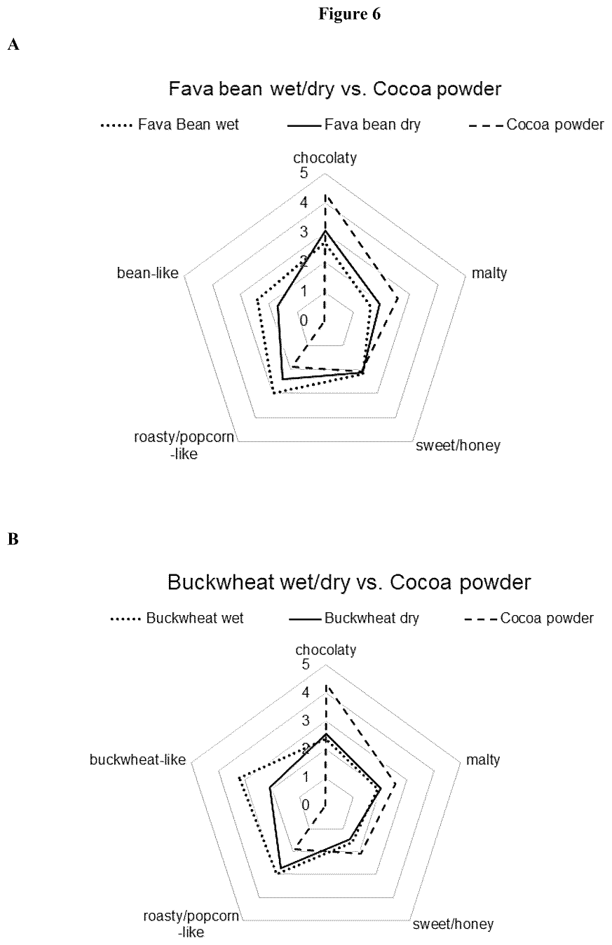

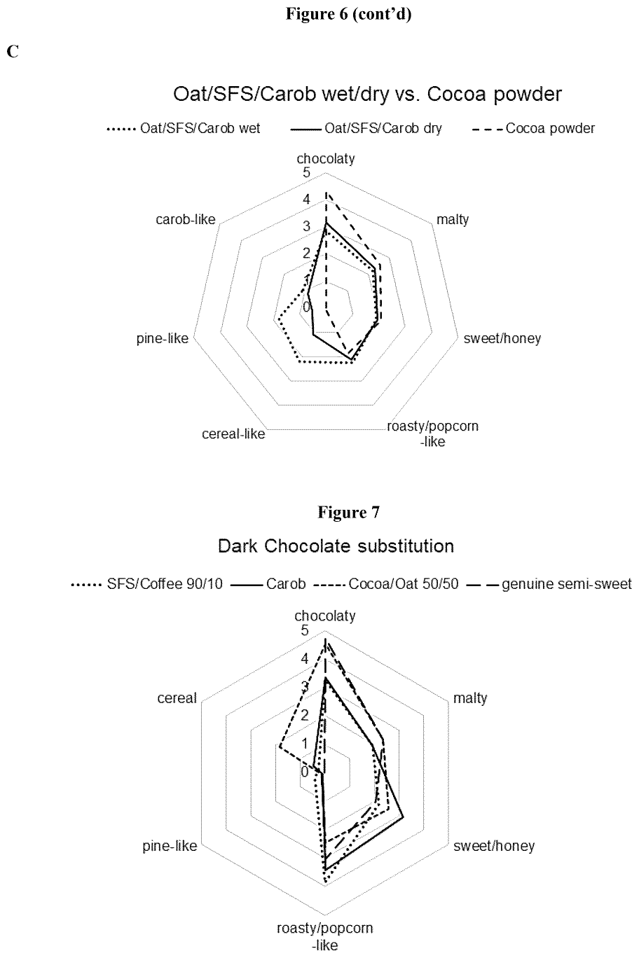

Results are shown in FIG. 6. In all examples, off-flavor of different raw materials is decreased, while the chocolaty/malty flavor is increased. With all tested raw materials, the overall sensory profile of dry incubated samples more strongly resembles the sensory profile of genuine dark chocolate. This demonstrates the superiority of dry incubation flavor compared to wet incubation flavor over a wide range of different raw material.

### Example 7: Spider Web Chart (Sensory) of Different Samples

Material/experimental:
Cocoa powder equivalent was prepared via dry incubation (150° C. 40 min, as described in Example 1) using different ingredients:
   90% SFS (flour from presscake), 10% spent and dried coffee grounds, AA/sugar/water
   100% Carob powder, AA/sugars/water
   50% Oat flour, 50% powdered fermented/unroasted Cocoa beans, AA/sugars/water
The cocoa powder equivalents were used to create a dark chocolate alternative (same ingredients as well, see Example 13)
As reference for the sensory a 50% cocoa content semi-sweet chocolate was used
Sensory-panelists (11 persons) were asked to rate the 3 chocolates according to the descriptors seen in the figure, on a scale from 0 to 5.

Results are shown in FIG. 7. It is shown that moderate to good chocolate alternatives can also be generated with different raw materials like the ones shown in this example. Also, raw cocoa beans can be processed. They can be “watered down” with other raw materials to still reach the desired chocolate aroma. This demonstrates that a profile similar to cocoa can be reached in different matrices.

### Example 8: Comparison of Chocolate Alternatives and Real Chocolate

Experimental:

Compared (sensorially) are the following chocolates (alternatives):
Vegan oat and sunflower-based milk-chocolate substitute made with cocoa powder equivalent as described in Example 12 (oat, sunflower, shea-butter based).
Commercially available competitor vegan carob-based milk-chocolate substitute (vegan carob chocolate substitute)
Reference: Commercially available vegan genuine milk (-like)-chocolate with cocoa (milk-like)

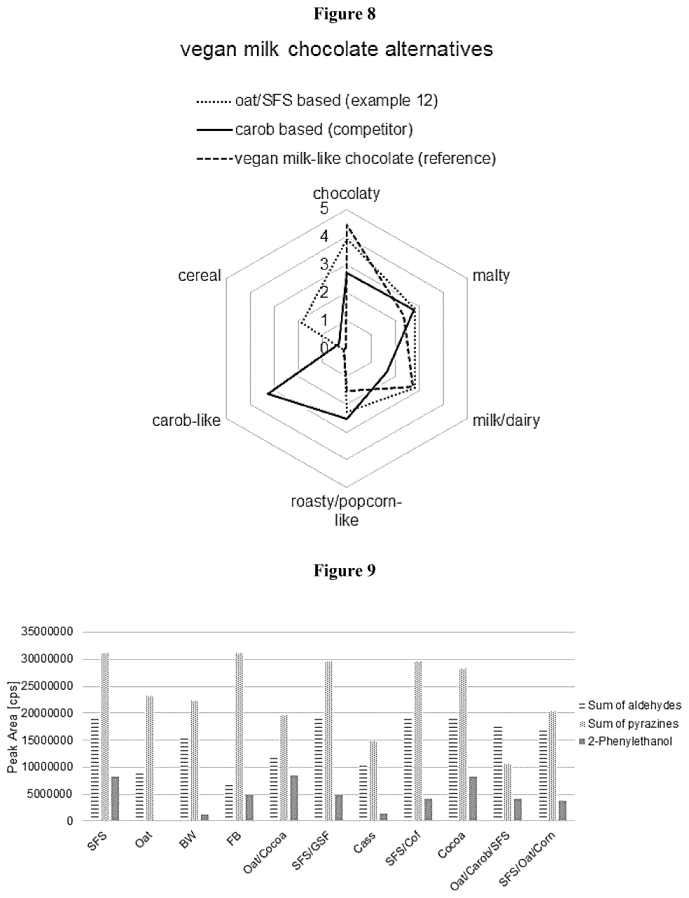

Results are shown in FIG. 8. A strong carob off-flavor is present in the competitor chocolate substitute (>3 of 5), while the chocolate substitute made according to Example 12 only has a rather mild cereal off-flavor (<2 of 5). Notably, the chocolate substitute made according to Example 12 is higher than in competitor and comes close to reference chocolate. Overall, the flavor profile of the chocolate substitute made according to Example 12 is closer to real chocolate than the competitor. Hence, chocolate substitutes of the present disclosure are more “chocolaty” and have less off-flavor and come closer to real chocolate than the tested competitor chocolate substitute.

### Example 9: Aroma Compound Concentrations in Real Experiment Samples

Material/experimental:

Cocoa powder equivalent was prepared via dry incubation incubation (150° C. 40 min, as described in Example 1) using different ingredients:
100% SFS (flour from presscake), AA/sugars/water
100% oat flour, AA/sugars/water
100% buckwheat flour, AA/sugars/water
100% fava bean flour, AA/sugars/water
50% Oat flour, 50% powdered fermented/unroasted Cocoabeans, AA/sugars/water
90% SFS (flour from presscake), 10% Grape Seed Flour, AA/sugars/water
100% Cassava root flour, AA/sugars/water
90% SFS (flour from presscake), 10% spent and dried coffee grounds, AA/sugars/water, AA/sugars/water
100% powdered fermented/unroasted Cocoabeans (no AA/sugars!)
33% Oat flour, 33% carob powder, 33% SFS (flour from presscake), AA/sugars/water
40% SFS (flour from presscake), 40% Oat flour, 20% Maize/corn flour, AA/sugars/water

Concentration of the following aroma compounds that are characteristic for chocolaty aroma have been analysed: aldehydes: 3-methylbutanal, 2-methylbutanal, 2-methylpropanal; pyrazines: 3-ethyl-2,10-dimethylpyrazine, 3-ethyl-2,10-dimethylpyrazine, 2-ethyl-6-methylpyrazine, 2-methyl-6-propoxypyrazine, 2,3-diethyl-5-methylpyrazine, 2,3-dimethylpyrazine; and 2-phenylethanol. Results are shown in FIG. 9. All tested samples show an flavorprofile that is similar to real cocoa. This demonstrates that a profile similar to cocoa can be reached in different matrices.

### Example 10: Aroma Compounds (Off-Flavors) Detected in the Condensed Water in Rotary Evaporator

To analyze off-flavor compounds that have been removed during dry incubation, condensed water from exhaust air of the rotary evaporator has been analyzed. Following off-flavor compounds have been detected:
Raw material sunflower seed flour (see Example 9): Acetoin (buttery), alpha-pinene (pine-like), Beta-pinene (pine-like).
Raw material oat (see Example 9): (E,E,Z)-2,4,6-nonatrienal (oatmeal-like), (E,E)-2,4-decadienal (chicken fat like), Hexanal (“green”, grassy).
Raw material fava beans (see Example 9): E-2-nonenal (fatty, “green”), Hexanal (“green”, grassy).
Raw material buckwheat (see Example 9): E-2-nonenal (fatty, “green”), (E,E)-2,4-decadienal (chicken fat like).
Raw material carob (see Example 7): Nonanal (aldehydic), Hexanoic acid (fatty).

This demonstrates that the application of vacuum during dry incubation effectively reduces off-flavor compounds.

### Example 11: Concentration of Certain Aroma Compounds (Analyzed by GC-MS)

Material/experimental:

Semi quantitation of volatile profiles of cocoa equivalents (CPEs) were performed using HS SPME-GC/MS. Ground CPEs were weighed in SPME vials (m=2.00±0.01 g). Samples were randomized prior to analysis, and the sequential injections were automated using a MultiPurpose Sampler (MPS) (Gerstel GmbH, Switzerland). A divinyl-benzene/carboxen/poly-dimethyl-siloxane (DVB/CAR/PDMS) SPME fibre assembly with a 50/30-μm-thick film (Supelco, Sigma-Aldrich Chemie GmbH, USA) and a Stabilwax (crossbond carbowax polyethylene glycol, 60 m: 320 μm·1 μm) column (Restek Pure Chromatography, USA) were used. MPS parameters were as follows: incubation—1 min at 60° C., agitating at 250 rpm; extraction time—30 min at 60° C.; pre-run bakeout—20 min at 230° C. A helium was used as a carrier gas at the constant column flow rate of 2.0 mL/min. The initial temperature of the GC oven was 35° C., kept for 4 min, heated to 250° C. at a rate of 7.5° C./min, followed by a five-minute hold time at final temperature. The mass spectra were recorded in the range 20 to 300 m/z with a data acquisition rate of 5 spectra·s−1. The MS detector and EI source was switched off during the first 3.75 min of solvent delay time. MassHunter GC/MS Acquisition software (Version B.07.06.2704, Agilent Technologies, Switzerland) and NIST20 spectrum database were used. Chemical identification was performed by comparing the MS spectra to the database and running reference-standards for confirmation. MS-Dial software was used for quantification.

The semi-quantification was performed using 13-trimethyldecanoic acid methyl ester as an internal standard at a concentration of 7.5 μg/kg in the CPE samples. The quantitative values were determined by dividing the area of the respective analyte by the area of 13-trimethyldecanoic acid methyl ester determined in the sample.

Results: all tested samples have significant amounts of 3-methylbutanal, 5-methyl-2-phenyl-2-hexenal, phenylacetaldehyde, trimethylpyrazine, and furaneol, which are characteristic for chocolaty aroma. All samples tested samples had
a. at least 0.1 relative peak area 3-methylbutanal;
b. at least 0.1 relative peak area 5-methyl-2-phenyl-2-hexenal;
c. at least 0.1 relative peak area phenylacetaldehyde;
d. at least 0.1 relative peak area trimethylpyrazine;
e. at least 0.1 relative peak area furaneol.

### Example 12: Preparation of Milk-Chocolate Substitute

Formulation: 120 g of the flavor composition prepared as described in Examples 1, 2 and 3 (150° C., 40 min, 100% AA/sugar), 339 g of cocoa butter equivalent (commercially available, based on palm fat, and shea butter), 323 g of sugar, 200 g of oat flour, and 18 g of coloring plant extracts were mixed to produce 1 kg of milk-chocolate substitute mass.

Milling: The mass was milled (3-roll roller grinder) to produce fine particles (D90, laser diffraction) of <30 μm.

Conching: The finely milled mass was then transferred into a conching device (Elkolino Conche, Buhler, Switzerland). The conching device was set to 60° C. and 1000 rpm for 2 hours. In the first hour, the conche was left open to remove residual light volatile acids, before the conching device was closed for the remaining 1 hour. At the end of the 2 hours, 20 minutes before stopping the conching, the lid was removed again and 4 g soy lecithin was added. The chocolate substitute was removed from the conche, tempered, and used like conventional chocolate, by molding the chocolate substitute into bars. The chocolate had a brownish color, similar to conventional dairy chocolate, and an intense chocolate-like, dairy, and creamy aroma. After cooling down and hardening, the bars had a shiny, firm surface, comparable to conventional dairy chocolate.

The properties of the final product were analyzed by sensory (n=9, FIG. 8 and Example 8). The sample was compared to a competitor sample that represented a vegan carob-based chocolate substitute and a genuine vegan milk-like-chocolate. The comparison demonstrates that the cereal off-flavor in our sample is very low compared to the carob-like off-flavor in the competitor sample. Also, the chocolaty flavor in our sample is more pronounced than in the competitor sample. Overall, the flavor of the sample produced by the new method is closer to a genuine chocolate than the competitor.

### Example 13: Dark Chocolate Substitute

Formulation: For 1 kg of dark-chocolate substitute, 160 g of the flavor composition, 340 g of cocoa butter equivalent (commercially available, based on palm fat, and shea butter), 400 g of sugar, 50 g of malted barley, 9.5 g of plant extracts as colorant, 0.5 g of salt, 40 g of grape seed flour were mixed. Milling: The mass was milled (3-roll roller grinder) to produce fine particles (D90, laser diffraction) of <30 μm.

Conching: The finely milled mass was then transferred into a conching device (Elkolino Conche, Buhler, Switzerland). The conche was set to 60° C. and 1000 rpm for 2 hours. In the first hour, the conche was left open to remove residual light volatile acids, before the conche was closed for the remaining 1 hour. At the end of the 2 hours, 20 minutes before stopping the conching, the lid was removed again and 4 g soy lecithin was added. The chocolate substitute was removed from the conche, tempered, and used like conventional chocolate, by molding the chocolate substitute into bars. The color and flavor of the bars were similar to dark chocolate.

Two dark chocolate substitutes were prepared using this formulation and preparation method. The first was prepared using dry incubated SFS and oats prepared as described in examples 1, 2 and 3 (150° C., 40 min, 100% AA/sugar) as the flavor composition. The second used wet incubated SFS and oats prepared as described in example 5 as the flavor composition.

The two samples and genuine dark chocolate with 50% cocoa content were presented to a panel (n=11) for sensory profile analysis of the flavor (FIG. 5 and Example 5). In dry incubated samples the cereal off-flavor is significantly decreased while the pine-like off-flavor is almost completely diminished compared to the wet incubated samples. Additionally, the chocolatiness is slightly increased in dry incubated samples compared to wet incubated samples. Otherwise, the aroma of the two samples is similar to each other. Because of this, the aroma of the dry incubated chocolate alternative is closer to the flavor profile of a genuine dark chocolate. Both samples have compared to the genuine dark chocolate a higher malty and sweet/honey aroma, while the chocolaty flavor is higher in the genuine chocolate.

### Example 14: Comparison Between From Wet Incubated Sunflower Kernels and Dry Incubated Sunflower Flour

This experiment emphasize the advantage of using powder and therefore deoiled sunflower seed flour. We produce chocolate substitute from wet incubated sunflower kernels and dry incubated sunflower flour. Both chocolate substitutes are analyzed by texture analyser and by GC-MS.

Two cocoa powder equivalents (CPE) were prepared—one from sunflower flour (dry incubation—new process) and one from sunflower seeds (wet incubation)

The amino acids and sugars (7.28 g) used for both CPEs were exactly the same.

Both CPE were vacuum treated and roasted with the same conditions:

Weighed 200 g sunflower seeds/flour, 200 ml distilled water for wet incubation and 20 ml for dry incubation and 7.28 g of the AA/sugar mix into the thermomix, mixed at 90° C. for 20 min.

Discarded the remaining water through a sieve (only wet incubation) and transferred the seeds/flour into a 1 L powder flask. Drying in a rotational evaporator at 90° C. for 140 min at 100 mbar and an additional 75 min at 64 mbar to reach a moisture content of <5%. The roasting was performed in an 130° C. oil bath in the rotational evaporator at ambient pressure for 25 min.

CPEs were analyzed by GC-MS directly as triplicates.

CPEs were used to make chocolate substitute with the exact same recipe:

CPEs were mixed with sugar, fat, colorant, skimmed milk powder and then ground to a particle size <30 μm. Then conched and lecithin was added.

The chocolate substitute was moulded and tempered in 6.6 cm*3.2 cm*0.6 cm moulds and analysed with a texture analyser.

Texture analyzer method:

The instrument used was a Texture Analyser TA-xt2i (TA instruments) with a 5 kg measuring cell and a 3-point measuring module. The instrument was set so the upper arm travels a certain distance per time (0.5 mm/s). As soon as the arm reaches the chocolate substitute bar and the arm senses resistance, the instrument starts to record the data and the arm travels further 5 mm (10 seconds) to break the chocolate substitute bar. The instrument records the force as “gram” and the time in seconds.

Results:

GC analysis:

To quantify the lipid-oxidation process in the sunflower CPE (wet and dry Inc) certain volatile oxidation markers were semi-quantified by GC-MS.

Sunflower oil consists mostly of Linoleic acid (>50%). Thus, as a marker of lipid-oxidation of the sunflower CPE, the degradation products of the autooxidation of Linoleic acid were analysed. According to Belitz et al. (2008), Lehrbuch der Lebensmittelchemie page 207, and Myazaki et al. (2022), Bioscience, Biotechnology, and Biochemistry, Volume 87, Issue 2, February 2023, Pages 179-190 E-2,4-Decadienal, E-oct-2-enal, 1-octen-3-ol, Hexanal and 2-Pentylfuran are such volatile compounds.

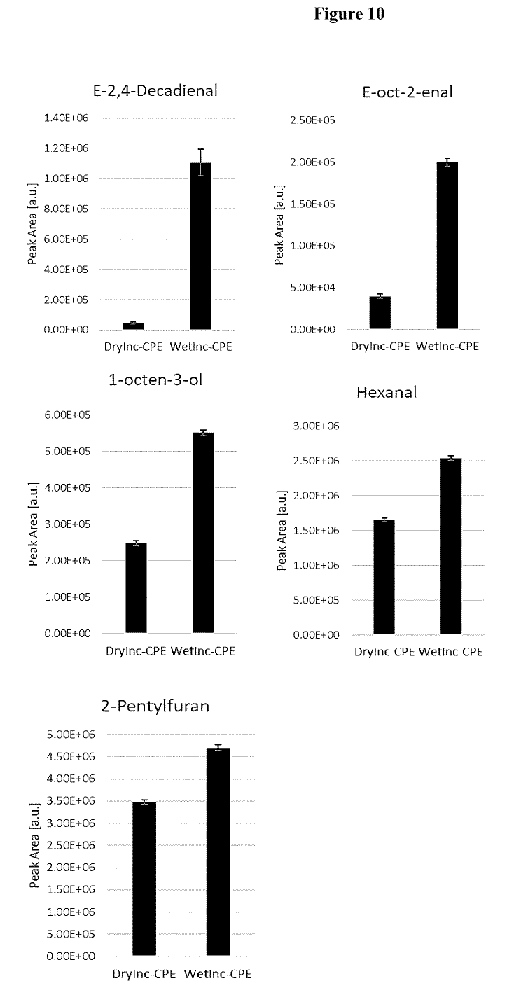

FIG. 10 show that the specified markers are more prevalent in the CPE that was prepared by the “wet incubation” method. The suggested reason is the higher amount of sunflower oil that is contained in the CPE. The sunflower oil in the CPE is undergoing autooxidation during the high temperatures during the roasting process. This is leading to rancid, fatty off-flavors in the CPE. Furthermore, since the autooxidation of lipids is a chain-reaction (Belitz et al. 2008), it means once it is started, it will accelerate even more ahead in time. This means that the long term shelf-life of a product with already started autooxidation is also shorter.

Texture analysis:

The recorded data confirms the assumption that the presence of additional sunflower oil in the chocolate substitute bars leads to a softer texture of the bars.

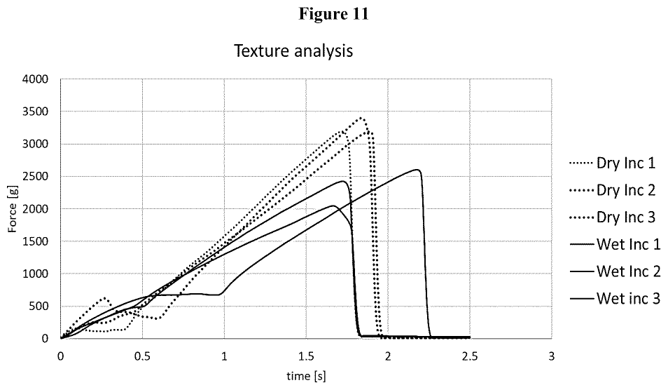

As shown in FIG. 11, the force/time curves for the chocolate substitute bars (analyzed as triplicates) made with dry incubated CPE are more steep and the maximum force applied before the bar broke was higher. This proves a harder texture. A harder texture is usually preferred in chocolate products, because it leads to a “knack” sensation when biting into the chocolate, which is preferred most of the times. The chocolate substitute bars made from wet incubated CPE had less steep curves and lower maximum force before breaking, due to the softer texture.

In summary, lipid-oxidation products could be detected in higher amounts in wet incubated SFS than in dry incubated SFS. Also, the chocolate substitute produced with wet incubation SFS was softer than the one produced with dry incubated SFS.

Embodiments illustratively described herein may suitably be practiced in the absence of any element or elements, limitation or limitations, not specifically disclosed herein. Thus, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present embodiments have been specifically disclosed by preferred embodiments and optional features, modification and variations thereof may be resorted to by those skilled in the art, and that such modifications and variations are considered to be within the scope of this invention. Each of the narrower species and subgeneric groupings falling within the generic disclosure also forms part of the invention. This includes the generic description of the invention with a proviso or negative limitation removing any subject matter from the genus, regardless of whether or not the excised material is specifically recited herein. In addition, where features are described in terms of Markush groups, those skilled in the art will recognize that the disclosure is also thereby described in terms of any individual member or subgroup of members of the Markush group.

Equivalents: Those skilled in the art will recognize or be able to ascertain using no more than routine experimentation, many equivalents to the specific embodiments of the invention described herein. Such equivalents are intended to be encompassed by the following claims.

It should be understood that this invention is not limited to the particular methodology, protocols, material, reagents, and substances, etc., described herein and as such can vary. The terminology used herein is for the purpose of describing particular embodiments only, and is not intended to limit the scope of the present invention, which is defined solely by the claims.

All publications cited throughout the text of this specification (including all patents, patent applications, scientific publications, manufacturer's specifications, instructions, etc.) are hereby incorporated by reference in their entirety. Nothing herein is to be construed as an admission that the invention is not entitled to antedate such disclosure by virtue of prior invention. To the extent the material incorporated by reference contradicts or is inconsistent with this specification, the specification will supersede any such material.

Further embodiments will become apparent from the following claims.

1. A method of preparing a cocoa or chocolate flavor composition comprising
(a) applying vacuum of 500 mbar or less at a temperature of 60-90° C. to a raw composition comprising:
(i) 50-99.7 wt.-% (based on dry matter) of a ground material, wherein the ground material is one or more selected from the group consisting of oats, sunflower seeds, apricot kernels, plum kernels, peach kernels, cherry kernels, almond, jackfruit seeds, carob, beans, cereals, pseudo-cereals, non-cereal grains, yeast, grape seed, fava bean, coffee, cassava root, and cocoa;
(ii) 0.2-4 wt.-% (based on dry matter) of the following amino acids: leucine, isoleucine, phenylalanine, lysine, and/or proline;
(iii) 0.1-15 wt.-% (based on dry matter) reducing sugar; and
(iv) 5-40 wt.-% water (of dry matter);
until the composition has a moisture content of 15%% or lower, to give a dry intermediate product; and
(b) roasting the dry intermediate product at a temperature of at least 80° C., preferably 110-180° C. to obtain a roasted product.

2. The method of claim 1, wherein the method comprises incubating the raw composition at 50-80° C. for up to 120 minutes before step (a).

3. The method of claim 1, wherein the raw composition is prepared by
(i) providing ground material,
(ii) providing steam and/or water; and
(iii) providing the amino acids and reducing sugar.

4. The method of claim 1, wherein the ground material is one or more selected from the group consisting of: oats flour, sunflower meal, buckwheat flour, fava bean flour, cocoa bean powder, grape seed flour, cassava root flour, coffee grounds, carob powder, and corn flour, preferably one or more selected from the group consisting of: oats flour, sunflower meal, buckwheat flour, cocoa bean powder, grape seed flour, cassava root flour, coffee grounds, carob powder, and corn flour.

5. The method of claim 1, wherein the ground material is selected from:
(a) a mixture of oats and sunflower seeds;
(b) fava beans;
(c) buckwheat;
(d) a mixture of oats, sunflower seeds and carob;
(e) carob;
(f) a mixture of sunflower seeds and coffee beans;
(g) a mixture of oats and cocoa beans;
(h) sunflower seeds;
(i) oats;
(i) a mixture of sunflower seeds and grape seeds;
(k) cassava roots; and
(l) a mixture of sunflower seeds, oats, and corn.

6. The method of claim 1, wherein the ground material is selected from the group consisting of: oats flour, sunflower meal, or a mixture thereof.

7. The method of claim 1, wherein the ground material is a de-oiled ground material and/or wherein the ground material is obtained from a press cake or oil cake.

8. The method of claim 1, wherein the leucine, isoleucine, phenylalanine, lysine, and/or proline are in free or acetylated form, and/or wherein the the leucine, isoleucine, phenylalanine, lysine, and/or proline are Maillard-reactive.

9. The method of claim 1, wherein the reducing sugar comprises one or more reducing sugars that is a monosaccharide and/or a disaccharide.

10. The method of claim 1, wherein the reducing sugar comprises one or more reducing sugars selected from the group consisting of glucose, fructose, ribose, xylose, mannose, galactose, lactose, and maltose.

11. The method of claim 1, wherein in step (a) at least one undesired flavor compound is depleted, such as acetoin, alpha-pinene, beta-pinene, (E,E,Z)-2,4,6-nonatrienal, (E,E)-2,4-decadienal, hexanal, E-2-nonenal; nonanal, and/or hexanoic acid.

12. The method of claim 1, wherein step (a) is conducted until the composition has a moisture content of 5% or lower.

13. The method of claim 1, further comprising adding fat and/or oil to the roasted product.

14. The method of claim 1, wherein the flavor composition is substantially free of cocoa or cocoa-derived solids.

15. The method of claim 1, comprising applying vacuum in step (a) and collecting, fractionating and/or isolating at least one flavor compound from exhaust air, and optionally adding the at least one flavor compound to the roasted product obtained in (b).

16. A cocoa or chocolate flavor composition, comprising a mixture of
(i) 50-99.9 wt.-% (based on dry matter) of a ground material, wherein the ground material is one or more selected from the group consisting of oats, sunflower seeds, apricot kernels, plum kernels, peach kernels, cherry kernels, almond, jackfruit seeds, carob, beans, cereals, pseudo-cereals, non-cereal grains, yeasts, grape seed, fava beans, coffee, cassava root, and cocoa;
(ii) 0.2-4 wt.-% (based on dry matter) of the following amino acids: leucine, isoleucine, phenylalanine, lysine, and/or proline;
(iii) 0.1-15 wt.-% (based on dry matter) reducing sugar; and
(iv) 5-40 wt.-% water (of dry matter);
that has undergone a drying step under vacuum of 500 mbar or less at a temperature of 60-90° C. and subsequently a roasting step at at least 80° C.

17. A method of preparing a conched confectionery product comprising conching a flavor composition of claim 16.

18. The flavor composition of claim 16, wherein the flavor composition is present as a component of a conched confectionery product.

19. The method according to claim 1, further comprising preparing a conched confectionery product by conching the roasted product.

20. A conched confectionery product comprising a flavor composition obtained by the method of claim 18.
